(19) United States
(12) Patent Application Publication
(10) Pub. No.: US 2026/0362180 A1
(43) Pub. Date: Nov. 12, 2026

(54) TECHNIQUES FOR MEASUREMENT CONFIGURATION BASED ON AN INTENT

(71) Applicant: QUALCOMM Incorporated, San Diego, CA (US)

(72) Inventors: Rajeev KUMAR, San Diego, CA (US); Olufunmilola Omolade AWONIYI-OTERI, San Diego, CA (US); Aziz GHOLMIEH, Del Mar, CA (US); Gavin Bernard HORN, La Jolla, CA (US); Miguel GRIOT, La Jolla, CA (US)

(21) Appl. No.: 19/391,266

(22) Filed: Nov. 17, 2025

Related U.S. Application Data
(60) Provisional application No. 63/802,190, filed on May 8, 2025.

(51) Int. Cl. H04W 24/08

(52) U.S. Cl. CPC H04W 24/08

(57) ABSTRACT

Various aspects of the present disclosure generally relate to wireless communication. In some aspects, a user equipment (UE) may receive an intent comprising a request for information associated with communications at the UE. The UE may generate, based at least in part on contextual information associated with the UE, a configuration for one or more measurements to obtain the information requested by the intent. The UE may perform, based at least in part on the configuration and to obtain the information requested by the intent, the one or more measurements associated with the intent. The UE may provide an indication of the one or more measurements. Numerous other aspects are described.

### CROSS-REFERENCE TO RELATED APPLICATION

This Patent Application claims priority to U.S. Provisional Patent Application No. 63/802,190, filed on May 8, 2025, entitled “TECHNIQUES FOR MEASUREMENT CONFIGURATION BASED ON AN INTENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with techniques for measurement configuration based on an intent.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A wireless communication network, such as a wireless communication network supporting LTE, NR (5G), and emerging technologies like 6G, may rely on a user equipment (UE) to collect and report measurement data for network optimization and management. In some wireless communication networks, measurement reporting may be governed by standardized protocols that specify predefined metrics, configurations, and procedures. These protocols may allow network entities (e.g., base stations or other network nodes) to instruct UEs on what data to collect, when to collect it, and how to report it. While effective in ensuring consistency and interoperability across devices and networks, these traditional approaches may be constrained by a reliance on rigid protocols and predefined measurement objects. As wireless communication networks evolve to support increasingly diverse use cases, such as autonomous vehicles, extended reality (XR), and massive machine-type communications (mMTC), the limitations of these rigid frameworks may become more pronounced.

### SUMMARY

The systems, methods, and devices of this disclosure each have several innovative aspects. In some cases, no single one of several innovative aspects is solely responsible for the desirable attributes disclosed herein.

Some aspects described herein relate to an apparatus. The apparatus may include one or more memories and one or more processors coupled to the one or more memories. The one or more processors, individually or collectively, may be configured to receive an intent comprising a request for information associated with communications at the apparatus. The one or more processors, individually or collectively, may be configured to generate, based at least in part on contextual information associated with the apparatus, a configuration for one or more measurements to obtain the information requested by the intent. The one or more processors, individually or collectively, may be configured to perform, based at least in part on the configuration and to obtain the information requested by the intent, the one or more measurements associated with the intent. The one or more processors, individually or collectively, may be configured to provide an indication of the one or more measurements.

Some aspects described herein relate to a method of wireless communication performed by a user equipment (UE). The method may include receiving an intent comprising a request for information associated with communications at the UE. The method may include generating, based at least in part on contextual information associated with the UE, a configuration for one or more measurements to obtain the information requested by the intent. The method may include performing, based at least in part on the configuration and to obtain the information requested by the intent, the one or more measurements associated with the intent. The method may include providing an indication of the one or more measurements.

Some aspects described herein relate to a non-transitory computer-readable medium that stores a set of instructions for wireless communication by a UE. The set of instructions, when executed by one or more processors of the UE, may cause the UE to receive an intent comprising a request for information associated with communications at the UE. The set of instructions, when executed by one or more processors of the UE, may cause the UE to generate, based at least in part on contextual information associated with the UE, a configuration for one or more measurements to obtain the information requested by the intent. The set of instructions, when executed by one or more processors of the UE, may cause the UE to perform, based at least in part on the configuration and to obtain the information requested by the intent, the one or more measurements associated with the intent. The set of instructions, when executed by one or more processors of the UE, may cause the UE to provide an indication of the one or more measurements.

Some aspects described herein relate to a UE. The UE may include a processing system. The processing system may include one or more processors and one or more code-storing memories coupled with the one or more processors. The processing system may be configured to cause the UE to receive an intent comprising a request for information associated with communications at the UE. The processing system may be configured to cause the UE to generate, based at least in part on contextual information associated with the UE, a configuration for one or more measurements to obtain the information requested by the intent. The processing system may be configured to cause the UE to perform, based at least in part on the configuration and to obtain the information requested by the intent, the one or more measurements associated with the intent. The processing system may be configured to cause the UE to provide an indication of the one or more measurements.

Some aspects described herein relate to an apparatus for wireless communication. The apparatus may include means for receiving an intent comprising a request for information associated with communications at the apparatus. The apparatus may include means for generating, based at least in part on contextual information associated with the apparatus, a configuration for one or more measurements to obtain the information requested by the intent. The apparatus may include means for performing, based at least in part on the configuration and to obtain the information requested by the intent, the one or more measurements associated with the intent. The apparatus may include means for providing an indication of the one or more measurements.

Aspects of the present disclosure may generally be implemented by or as a method, apparatus, system, computer program product, non-transitory computer-readable medium, UE, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example associated with techniques for measurement configuration generation based on an intent.

FIG. 3 is a diagram illustrating an example associated with techniques for measurement configuration generation based on an intent.

FIG. 4 is a diagram illustrating an example associated with techniques for measurement configuration generation based on an intent.

FIG. 5 is a diagram illustrating an example associated with techniques for measurement configuration generation based on an intent.

FIG. 6 is a diagram illustrating an example associated with techniques for measurement configuration generation based on an intent.

FIG. 7 is a diagram illustrating an example associated with techniques for measurement configuration generation based on an intent.

FIG. 8 is a diagram illustrating an example process performed, for example, at a user equipment (UE) or an apparatus of a UE.

FIG. 9 is a diagram of an example apparatus for wireless communication.

### DETAILED DESCRIPTION

A wireless communication network, such as a wireless communication network supporting LTE, NR (5G), and emerging technologies like 6G, may rely on a user equipment (UE) to collect and report measurement data for network optimization and management. In some wireless communication networks, measurement reporting may be governed by standardized protocols that specify predefined metrics, configurations, and procedures. These protocols may allow network entities (e.g., base stations or other network nodes) to instruct UEs on what data to collect, when to collect it, and how to report it. While effective in ensuring consistency and interoperability across devices and networks, these traditional approaches may be constrained by a reliance on rigid protocols and predefined measurement objects. As wireless communication networks evolve to support increasingly diverse use cases, such as autonomous vehicles, extended reality (XR), and massive machine-type communications (mMTC), the limitations of these rigid frameworks may become more pronounced.

Some wireless communication networks may benefit from increased flexibility in measurement collection and reporting processes. For instance, some wireless networks may account for dynamic environmental conditions, diverse connectivity types (e.g., terrestrial and non-terrestrial networks), varying user mobility patterns (e.g., pedestrian, vehicular, unmanned aerial vehicles (UAV) mobility patterns), and application-specific performance requirements (e.g., low latency for gaming or high throughput for streaming). However, existing frameworks may lack the capability to adapt to such dynamic requirements efficiently. The predefined nature of measurement and reporting configurations may prevent UEs from collecting and providing data tailored to specific or dynamic scenarios, which may result in suboptimal network performance.

Additionally, the growing complexity of wireless communication networks may introduce challenges into managing network inefficiencies. Issues such as coverage holes, high handover failure rates, beam switching delays, and radio link failures (RLFs) may be more adequately addressed with nuanced, context-sensitive analysis, which may enable wireless communication devices to identify root causes and implement corrective actions. Current systems may rely on static reporting configurations that fail to capture the full scope of these problems, especially in scenarios where dynamic environmental and operational contexts play a significant role. That is, network entities may define measurement configurations explicitly, leaving little room for UEs to interpret or adapt these instructions based on contextual information. For example, if a network entity instructs a UE to perform mobility management analysis, the UE may be configured (e.g., by the network entity, preconfigured such as based on a standardized protocol) to execute predefined measurement tasks without considering specific contextual factors like user location, speed, or environmental conditions (e.g., indoor versus outdoor). This lack of contextual adaptability may result in inefficiencies, such as collecting irrelevant data or failing to address pressing network issues in real-time.

In summary, some wireless communication networks may face technical challenges related to the rigidity of predefined protocols, and the inability to adapt to dynamic environmental and operational contexts. These challenges may limit the ability of UEs to perform efficient and meaningful data collection and reporting, thereby hindering network optimization and the ability to address emerging use cases effectively.

Various aspects relate generally to intent-driven measurement collection and reporting in wireless communication systems. Some aspects more specifically relate to a UE receiving an intent comprising a request for information associated with communications, generating a configuration for one or more measurements based on contextual information associated with the UE, performing the measurements in accordance with the configuration, and providing an indication of the measurements.

An intent may also be referred to as an intent request and may correspond to a natural language or plain-text request that represents a high-level goal for the UE to achieve. In some cases, the intent may include a request for information associated with communications at the UE. The intent may refer to a set of expectations that may include requirements, goals, conditions, and constraints. Unlike traditional measurement collection and reporting configurations, an intent may specify what the UE is to accomplish without detailing how the outcomes should be achieved. In some cases, an intent may be understandable by humans. Additionally, or alternatively, the UE may interpret the intent using an artificial intelligence (AI) component at the UE. The UE may autonomously determine the most effective method for achieving the specified objectives of the intent, which may enhance the flexibility and adaptability of accomplishing the specified objectives of the intent within a dynamic wireless communication environment.

In some aspects, the contextual information used to generate the configuration may include the UE's speed, location, capability information, or environmental information. The one or more measurements may include application layer measurements, signal quality measurements, performance measurements, or sensor measurements. The intent may be received from various entities, such as network nodes, other UEs, application servers, or internal components of the UE. For example, the UE may receive the intent from an AI component or protocol layer of the UE. The generated configuration may define measurement types, periodicity, triggering events, or connection contexts for performing the measurements. The connection contexts may include frequencies, cell information, tracking area codes, environments (e.g., indoor or outdoor), UE speed ranges, or types of established connections and services.

Particular aspects of the subject matter described in this disclosure may be implemented to realize one or more of the following technical benefits. By autonomously interpreting and translating intents into actionable measurement configurations (e.g., by generating, by a UE, a configuration for one or more measurements to obtain information associated with an intent), the described techniques may enable the UE to adapt measurement collection processes to diverse and dynamic network conditions. This adaptability may allow the UE to optimize data collection for critical use cases (e.g., beam management, mobility management, access performance analysis) without relying on rigid predefined protocols. Optimizing the data collection for critical use cases may decrease signaling overhead associated with data collection and reporting by decreasing a likelihood that the UE performs or reports unnecessary or redundant measurements. Additionally, the adaptability associated with the intent-driven measurement collection and reporting may improve the relevance of the data and measurements that are collected, thereby improving an overall performance at the UE. For example, if the UE implements intent-driven measurement collection and reporting for beam management, mobility management, or access performance analysis, the reliability of communications performed by the UE may be improved, the mobility management of the UE may be improved, and the access performance of the UE may be improved.

In some aspects, leveraging contextual information such as environmental conditions, UE capabilities, or connection contexts may enable more granular and precise measurement collection. For example, the UE may perform measurements based on connectivity type, network inefficiencies detected in specific geographic areas, or application-specific performance requirements. This context-aware adaptability may allow for targeted data collection that reduces unnecessary measurement overhead, leading to improved network diagnostics while conserving resources and bandwidth used for data collection or measurements.

Additionally, supporting autonomous decision-making and AI components at the UE may reduce a reliance on manual or static configuration instructions from the network. This may enable the UE to autonomously determine what measurements to perform, when to perform them, and how to report them, thereby improving responsiveness to emerging network issues such as coverage holes, capacity constraints, or RLFs. This improved responsiveness of the UE may improve a performance of the UE (e.g., a reliability of communications at the UE, a latency associated with communications at the UE). Additionally, the described techniques may conserve network signaling resources and reduce the load on centralized network management systems.

Overall, these techniques for measurement configuration generation at the UE based on an intent may address inefficiencies in traditional frameworks and enable resource-efficient support for diverse and complex use cases in modern and future wireless networks. In this way, the techniques may conserve processing resources, memory resources, network resources, or the like.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or AI or machine learning (ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

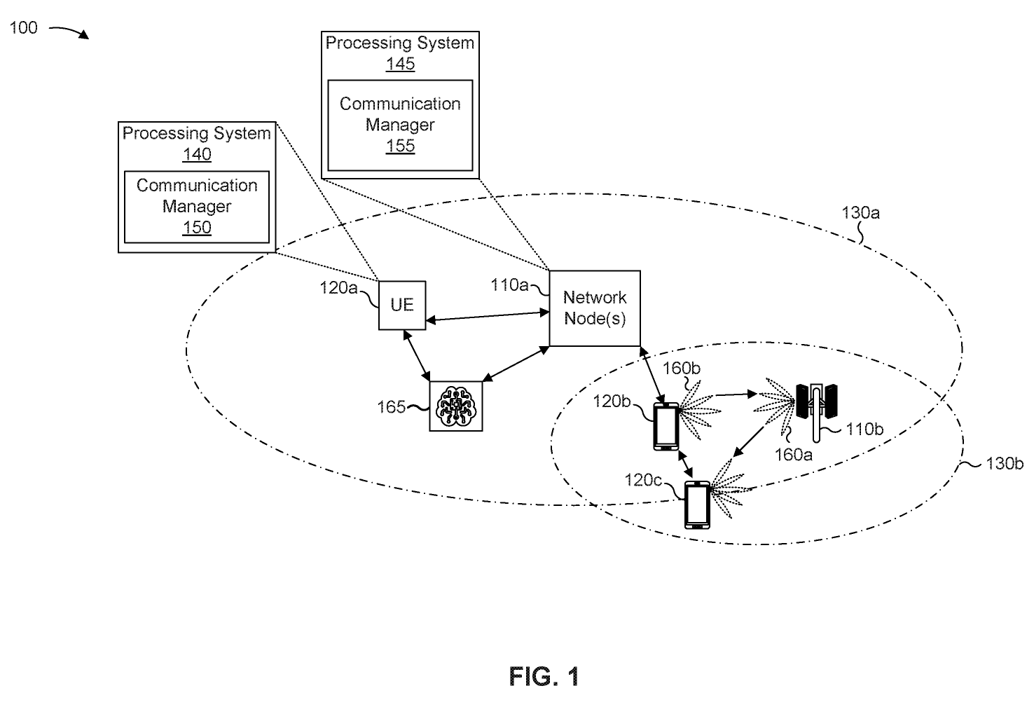

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 (that in turn includes a communication manager 150) and each network node 110 includes a processing system 145 (that in turn includes a communication manager 155). A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open RAN (O-RAN) (such as a network configuration in compliance with the O-RAN Alliance), or in a virtualized RAN (vRAN), also known as a cloud RAN (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

The UEs 120 may be physically dispersed throughout the coverage areas 130 of the wireless communication network 100 (e.g., the coverage area 130a and the coverage area 130b), and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing AI, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi-co-location (QCL) parameter, among other examples.

Some aspects and techniques as described herein may be implemented, at least in part, using an AI program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience, positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, they may include a communication manager 150. As described in more detail elsewhere herein, the communication manager 150 may receive an intent comprising a request for information associated with communications at the UE; generate, based at least in part on contextual information associated with the UE, a configuration for one or more measurements to obtain the information requested by the intent; perform, based at least in part on the configuration and to obtain the information requested by the intent, the one or more measurements associated with the intent; and provide an indication of the one or more measurements. Additionally, or alternatively, the communication manager 150 may perform one or more other operations described herein.

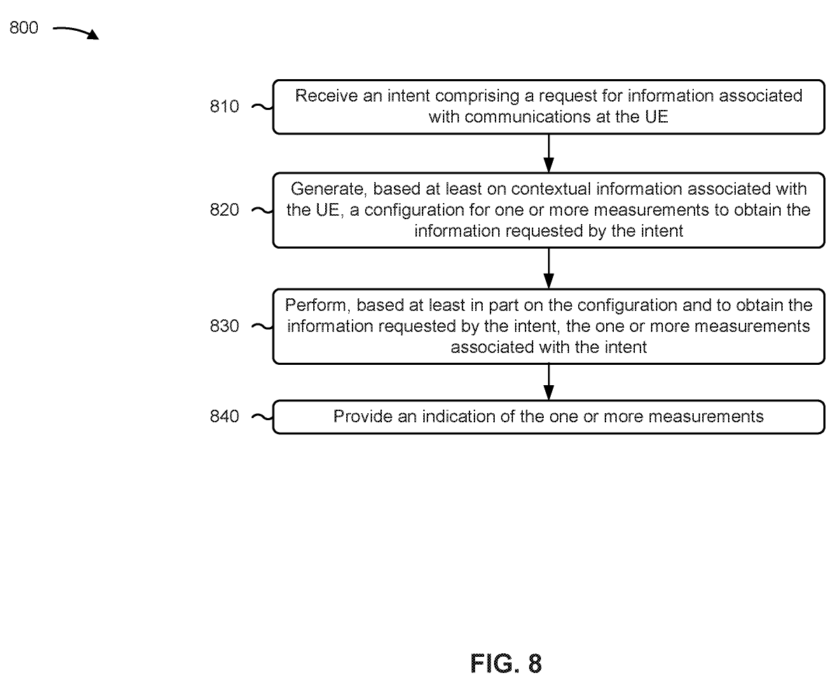

The network node 110, the processing system 145 of the network node 110, the UE 120, the processing system 140 of the UE 120, or any other component(s) of FIG. 1 may implement one or more techniques or perform one or more operations associated with measurement configuration generation based on an intent, as described in more detail elsewhere herein. For example, the processing system 145 of the network node 110, or the processing system 140 of the UE 120 may perform or direct operations of, for example, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, or other processes as described herein. In some examples, executing instructions may include running the instructions, converting the instructions, compiling the instructions, or interpreting the instructions, among other examples.

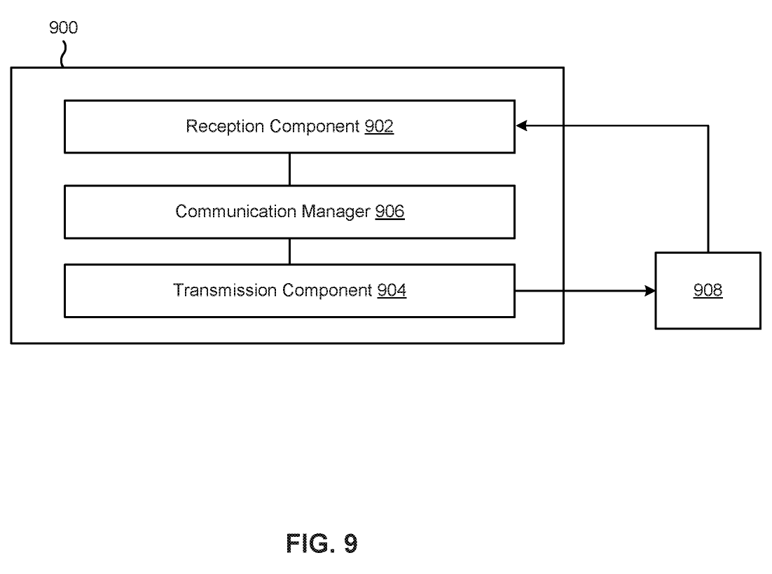

In some aspects, the includes means for receiving an intent comprising a request for information associated with communications at the UE; means for generating, based at least in part on contextual information associated with the UE, a configuration for one or more measurements to obtain the information requested by the intent; means for performing, based at least in part on the configuration and to obtain the information requested by the intent, the one or more measurements associated with the intent; or means for providing an indication of the one or more measurements. In some aspects, the means for the to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

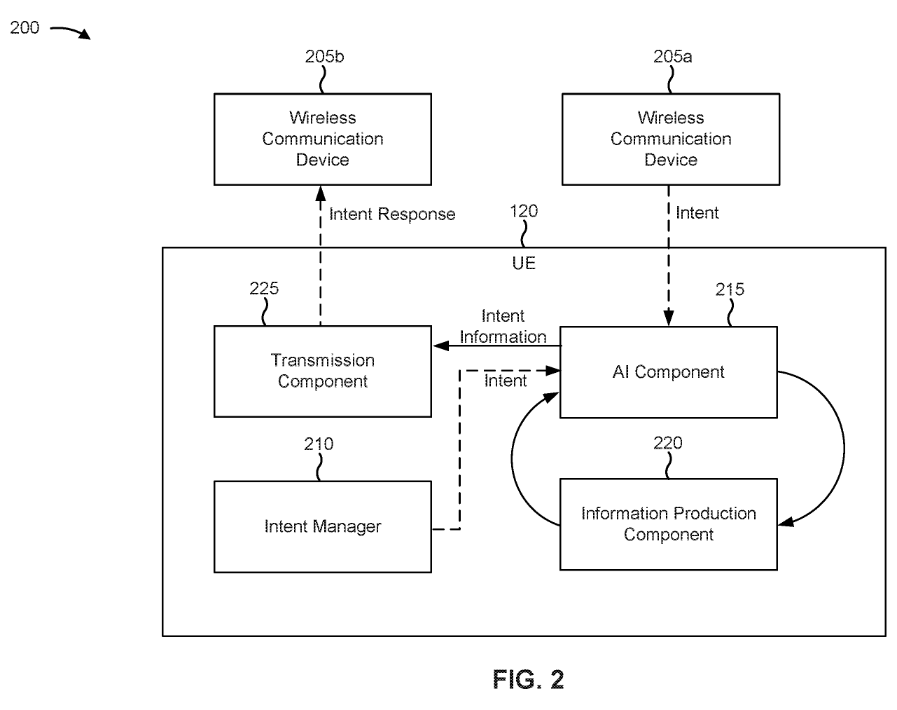

FIG. 2 is a diagram illustrating an example 200 associated with techniques for measurement configuration generation based on an intent. As shown in FIG. 2, the UE 120 may include an intent manager 210, an AI component 215, an information production component 220, and a transmission component 225.

The UE 120 may be configured to perform intent-driven measurement collection and reporting. An intent, also referred to as an intent request, may correspond to a natural language or plain-text request that represents a high-level goal for the UE 120 to achieve. The intent may refer to a set of expectations that may include requirements, goals, conditions, and constraints. For example, unlike traditional measurement collection and reporting configurations, an intent may specify what the UE 120 is to accomplish without detailing how the outcomes should be achieved. In some cases, an intent may be understandable by humans. Additionally, or alternatively, the UE 120 may interpret the intent using an AI component 215 at the UE 120. The UE 120 may autonomously determine the most effective method for achieving the specified objectives of the intent, which may enhance the flexibility and adaptability of accomplishing the specified objectives of the intent within a dynamic wireless communication environment.

For example, a requirement associated with an intent may include specific data types to be collected, minimum signal quality thresholds, or compliance with certain communication standards. Additionally, an example of a goal associated with an intent may encompass objectives such as optimizing network performance, reducing latency, or enhancing user experience. In some cases, a condition associated with an intent may include environmental factors like geographic location, time of day, or network congestion levels associated with executing the request indicated by the intent. An example of a constraint associated with an intent may correspond to a limitation associated with executing the request indicated by the intent, such as power consumption restrictions, bandwidth availability, or processing capacity.

In some cases, the intent may include or correspond to a request for information associated with communications at the UE 120. For example, the intent may include an indication for the UE 120 to perform network performance analysis, an indication for the UE 120 to determine network inefficiencies, an indication for the UE 120 to perform beam management performance analysis, an indication for the UE 120 to perform mobility management performance analysis, or an indication for the UE 120 to perform access performance analysis. The UE 120 may autonomously interpret and translate the intent into actionable measurement tasks.

As shown in FIG. 2, the UE 120 may receive an intent from either another wireless communication device 205a or may generate the intent internally (e.g., as illustrated by the intent manager 210 providing the intent to the AI component 215). The other wireless communication device 205a may correspond to a network entity (e.g., a RAN node, a network function or service, or an application server in the network) or another UE. If the other wireless communication device 205a is another UE that transmits the intent to the UE 120, the other UE may transmit the intent via a sidelink, via a WiFi connection, via Bluetooth, or via another type of wired or wireless connection.

The UE 120 may also receive an intent from another component in the UE 120. That is, the AI component 215 of the UE 120 may receive an intent from another component within the UE 120. In the example of FIG. 2, the other component is illustrated as an intent manager 210. The intent manager 210 may correspond to another AI component 215 at the UE 120, an application at the UE 120, or another protocol layer (e.g., that is distinct from the AI component 215) at the UE 120.

The AI component 215 may receive an intent (e.g., from the wireless communication device 205a or from the intent manager 210) and generate a configuration for one or more measurements to obtain the information requested by the intent. The AI component 215 may correspond to an AI agent. An AI agent may be an intelligent assistant capable of interpreting intents and interacting with various environments. The AI component 215 may access contextual information, engage in sophisticated reasoning (e.g., using AI, using ML), and perform self-reflection and self-learning. The AI component 215 may utilize tools, make decisions, plan, and take actions autonomously to execute multi-step tasks associated with an intent, either independently or in collaboration with other AI components at the UE 120 or another AI agent that is external to the UE 120. That is, some third-party application servers or application servers within the network may host one or more other AI agents.

The AI component 215 may enable the UE 120 to perform intent-driven measurement collection and reporting. In some cases, the AI component 215 may implement a generative AI model, such as a large vocabulary model (LVM), a large memory model (LMM), or a large language model (LLM), to autonomously interpret and translate intents into actionable measurement tasks.

The AI component 215 may be in communication with an information production component 220 at the UE 120 to obtain the information associated with an intent. The information production component 220 may produce or otherwise obtain the information requested by the intent. The information production component 220 may correspond to one or more data producers at the UE 120. For example, the information production component 220 may include one or more sensors at the UE 120, a processing system (such as the processing system 140), or a communication manager (such as the communication manager 150). The information production component 220 may be configured to perform one or more measurements associated with communications at the UE 120. For example, the AI component 215 may provide, to the information production component 220, configuration information for one or more measurements to obtain information associated with an intent, and the information production component 220 may perform the one or more measurements to obtain the information.

The AI component 215 may be capable of continuously adjusting the configuration (e.g., based on contextual information, based on events detected by the UE 120) to fulfill an intent (or to fulfill a requirement indicated by the intent). Here, the AI component 215 may provide an indication of the adjustments to the configuration to the information production component 220. The information production component 220 may provide, to the AI component 215, an indication of the collected data or measurements that the information production component 220 obtains in accordance with the configuration. Based on the indication of the collected data or measurements, the AI component 215 may update the configuration and provide the updated configuration to the information production component 220. Accordingly, the AI component 215 and the information production component 220 may obtain the information associated with an intent (e.g., the intent information).

The information requested by the intent, which may also be referred to as intent information, may include an indication of the one or more measurements performed by the information production component 220 (e.g., in response to or in accordance with the configuration generated by the AI component 215). In some cases, the AI component 215 may provide the intent information to another component within the UE 120. That is, the entity that consumes the intent response may correspond to an entity within the UE 120. For example, the AI component 215 may provide the intent response to another AI component 215 at the UE 120, an application at the UE 120, or another protocol layer (e.g., that is distinct from the AI component 215) at the UE 120.

In some other cases, the AI component 215 may provide, to the transmission component 225, the intent information. The transmission component 225 may then output the intent information within an intent response. In some cases, the transmission component 225 may transmit the intent response to another wireless communication device 205b. While illustrated as distinct from the wireless communication device 205a, the wireless communication device 205b may be the same as the wireless communication device 205b. That is, the entity (e.g., the wireless communication device 205a) that generates the intent may be the same as the entity (e.g., the wireless communication device 205b) that consumes the intent response. In some other cases, the entity (e.g., the wireless communication device 205a) that generates the intent may be different from the entity (e.g., the wireless communication device 205b) that consumes the intent response. The other wireless communication device 205b may correspond to a network entity (e.g., a RAN node, a network function or service, or an application server in the network) or another UE.

As indicated above, FIG. 2 is provided as an example. Other examples may differ from what is described with respect to FIG. 2.

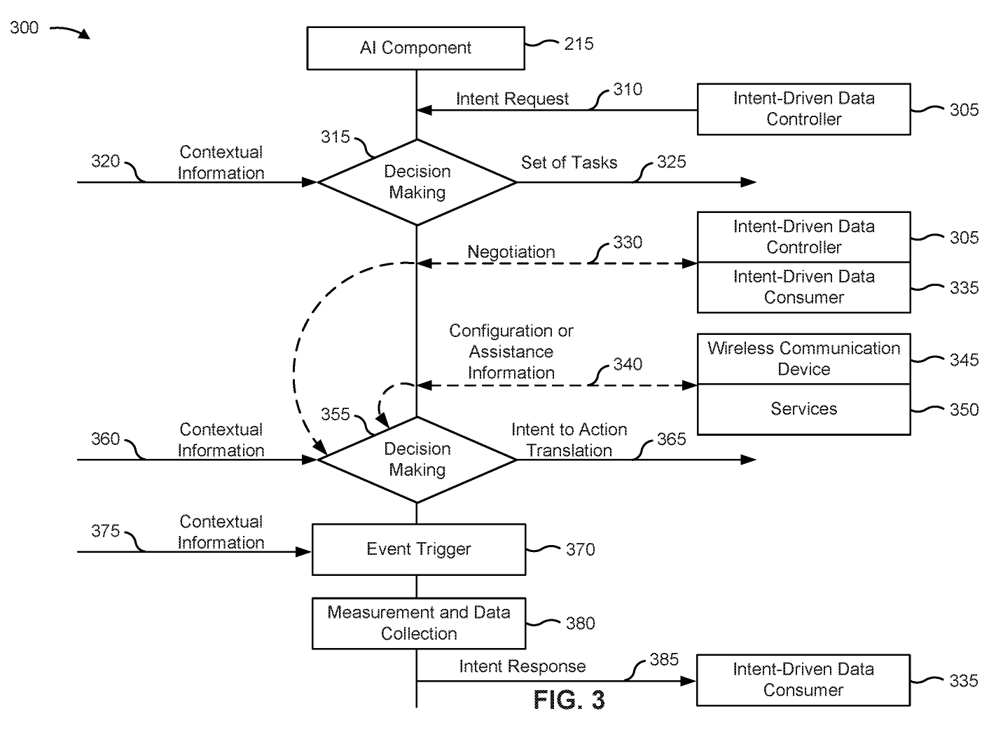

FIG. 3 is a diagram illustrating an example 300 associated with techniques for measurement configuration generation based on an intent. FIG. 3 may illustrate one or more operations performed by an AI component 215 within a UE 120 (e.g., which may correspond to the AI component 215 described with reference to FIG. 2). The AI component 215 may be capable of performing intent-driven measurement collection and reporting, as described herein.

The AI component 215 may receive, from an intent-driven data controller 305, an intent request 310. The intent-driven data controller 305 may correspond to the component, device, or entity that generates the intent request 310. The intent-driven data controller 305 may be within the UE 120 or outside the UE 120. For example, if the intent-driven data controller 305 is within the UE 120, the intent-driven data controller 305 may correspond to another AI agent at the UE 120 (e.g., another AI component at the UE 120), another protocol layer at the UE 120, or an application at the UE 120. Additionally, if the intent-driven data controller 305 is outside of the UE 120, the intent-driven data controller 305 may correspond to an application server in the network, a RAN node, a network function or service, or another UE.

information 320. Based on the input contextual information 320 and the intent request 310, the AI component 215 may output, as part of the one or more decision making procedures 315, a set of tasks 325 that are associated with the intent request 310. That is, the AI component 215 may use the contextual information 320 to determine the set of tasks 325 that are associated with the intent request 310. The set of tasks may correspond to more specific intents that are associated with the received intent request 310. That is, the AI component 215 may determine different, more specific, intents that are associated with the configured intent (e.g., the intent request 310).

The AI component 215 may optionally perform a negotiation 330 with the intent-driven data controller 305 or an intent-driven data consumer 335. The intent-driven data consumer 335 may correspond to the component, device, or entity that consumes (e.g., that processes) the intent response 385 (e.g., generated by the AI component 215 based on receiving the intent request 310). In some cases, the negotiation 330 may include the AI component 215 proposing, to the intent-driven data controller 305 or the intent-driven data consumer 335, the set of tasks 325 associated with the intent request 310. Then the intent-driven data controller 305 or the intent-driven data consumer 335 may indicate one or more of the tasks from the set of tasks 325 for the AI component 215 for which to collect information as part of performing the intent request 310.

Additionally, or alternatively, the negotiation 330 may include the AI component 215 proposing, to the intent-driven data controller 305 or the intent-driven data consumer 335, one or more measurements, measurement parameters, or measurement configurations to obtain information associated with the intent request (e.g., the information requested by the intent request). Then the intent-driven data controller 305 or the intent-driven data consumer 335 may perform a decision making procedure (e.g., using another AI agent) to determine and select the proposed measurements, measurement parameters, or measurement configurations that are likely to obtain the most relevant or useful information for the intent request. The intent-driven data controller 305 or the intent-driven data consumer 335 may then provide an indication of the selected measurements, measurement parameters, or measurement configurations to use for the intent request.

The AI component 215 may optionally exchange configuration or assistance information 340 with another wireless communication device 345 or with one or more services 350. For example, some measurement or measurement configurations may require network assistance and configuration. If the AI component 215 identifies such measurements or measurement configurations to obtain information for the intent request 310, the AI component 215 may request configuration information from another wireless communication device 345 (e.g., a network entity), and the wireless communication device 345 may provide configuration information in response to the request. Additionally, or alternatively, the AI component 215 may request assistance information from one or more services 350 to obtain information for the intent request 310. For example, the AI component 215 may request sensing or positioning service assistance information (e.g., associated with navigation or trajectory tracking). In some cases, the one or more services 350 may then provide the requested assistance information.

The AI component 215 may perform one or more decision making procedures 355. In particular, the AI component 215 may receive, as an input, contextual information 360, information associated with the negotiation 330 (e.g., if the AI component 215 performed the negotiation 330), or configuration or assistance information 340 (e.g., if the AI component 215 communicated the configuration or assistance information 340). The contextual information 360 may be the same as the contextual information 320 ,or may be different or more recently collected or received than the contextual information 320. Based on the input contextual information 360, the information associated with the negotiation 330, or the configuration or assistance information 340, the AI component 215 may output, as part of the one or more decision making procedures 355, an intent to action translation 365.

The intent to action translation 365 may include a configuration for one or more measurements to be performed by the UE 120 to obtain the information associated with the intent request (e.g., the information requested by the intent request). In particular, the intent to action translation 365 may include an indication of what measurements or data are to be performed or collected (e.g., application, radio, or sensing measurements) to obtain the information for the intent request. Additionally, the intent to action translation 365 may include an indication of when the measurements or data are to be performed or collected. That is, the intent to action translation 365 may indicate one or more events associated with triggering the UE 120 to perform the measurements or collect the data indicated by the intent to action translation 365.

The AI component 215 may detect an event trigger 370. That is, the AI component 215 may receive the contextual information 375 (which may the same as the contextual information 360 or the contextual information 320, or may be different or more recently collected or received than the contextual information 360 or the contextual information 320) and, based on the contextual information 375, detect the event trigger 370.

The AI component 215 may initiate or perform the measurement or data collection 380. That is, the AI component 215 may initiate or perform the measurement or data collection 380 based on the event trigger 370.

The AI component 215 may output, to an intent-driven data consumer 335, an intent response 385. The intent response 385 may include an indication of the performed measurement or the collected data. That is, the intent response 385 may include information associated with the intent request 310 (e.g., the information requested by the intent request 310).

As indicated above, FIG. 3 is provided as an example. Other examples may differ from what is described with respect to FIG. 3.

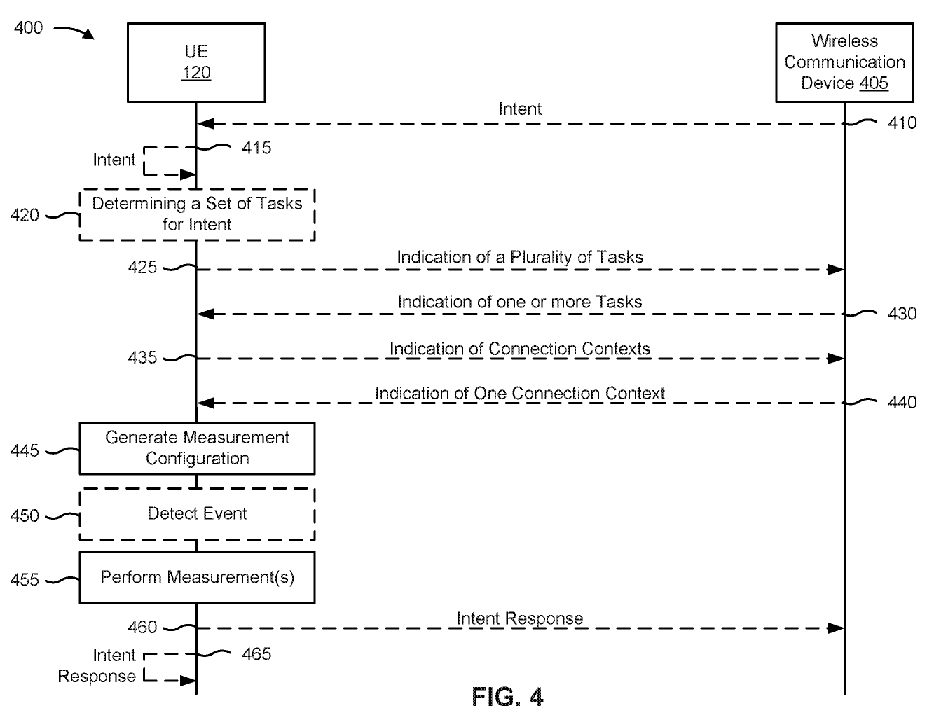

FIG. 4 is a diagram illustrating an example 400 associated with techniques for measurement configuration generation based on an intent. As shown in FIG. 4, a UE 120 and another wireless communication device 405 may communicate with one another. The UE 120 may correspond to the UE 120 described with reference to FIGS. 1 and 2. For example, the UE 120 may include an AI component and the UE 120 may be capable of performing intent-driven measurement collection and reporting. The wireless communication device 405 may correspond to a network entity, another UE, a server, an application server associated with a network entity, a RAN node, a network function, or a network server.

As shown by reference number 410, the UE 120 may optionally receive,an intent from the wireless communication device 405. The intent may include a request for information associated with communications at the UE 120.

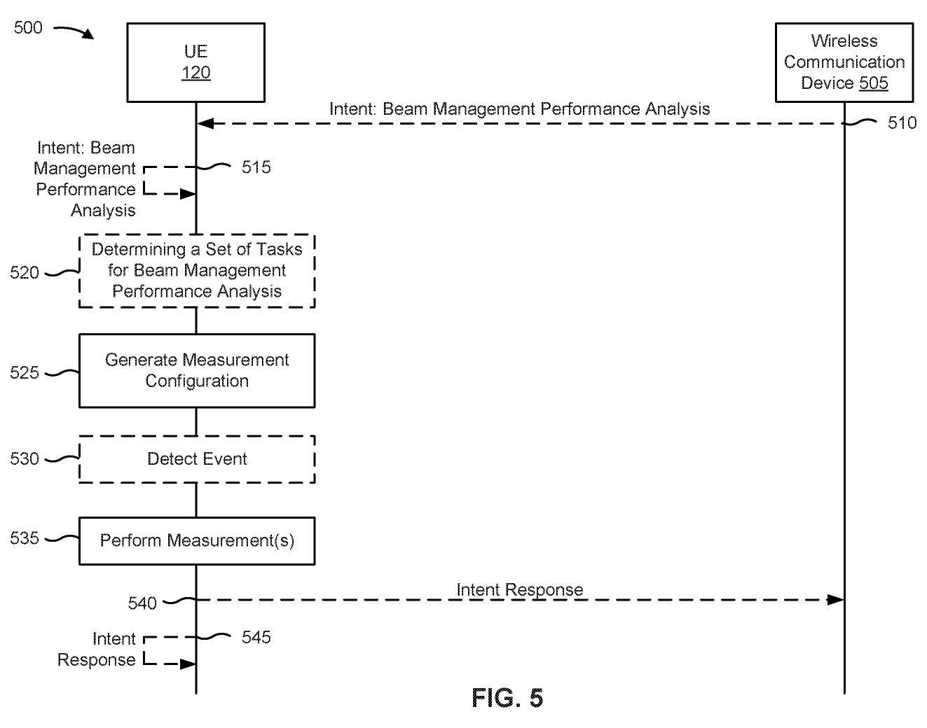

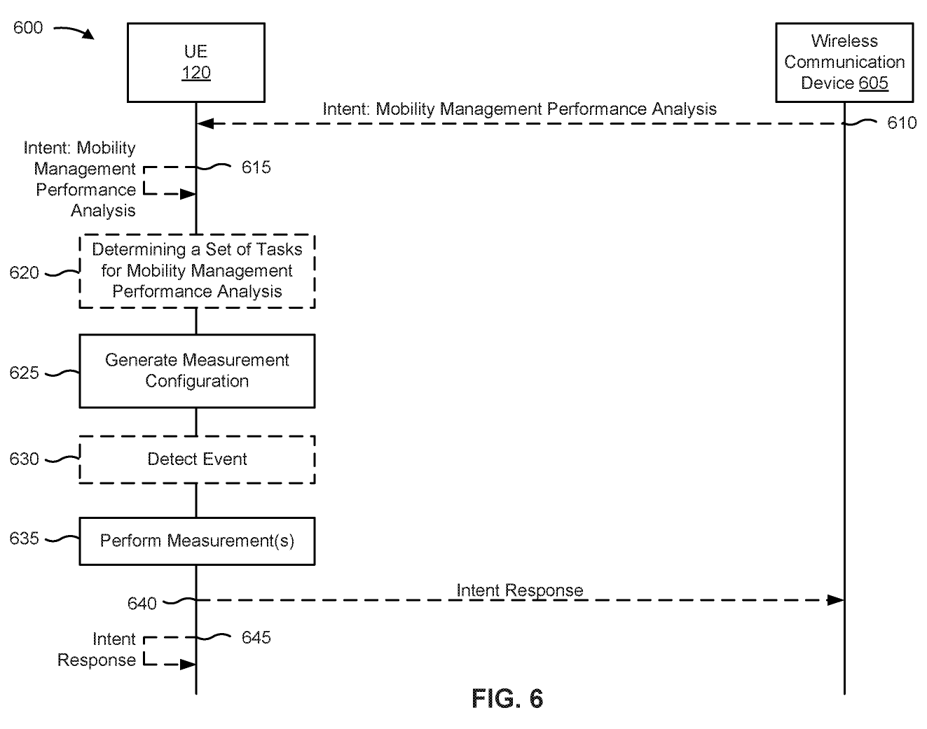

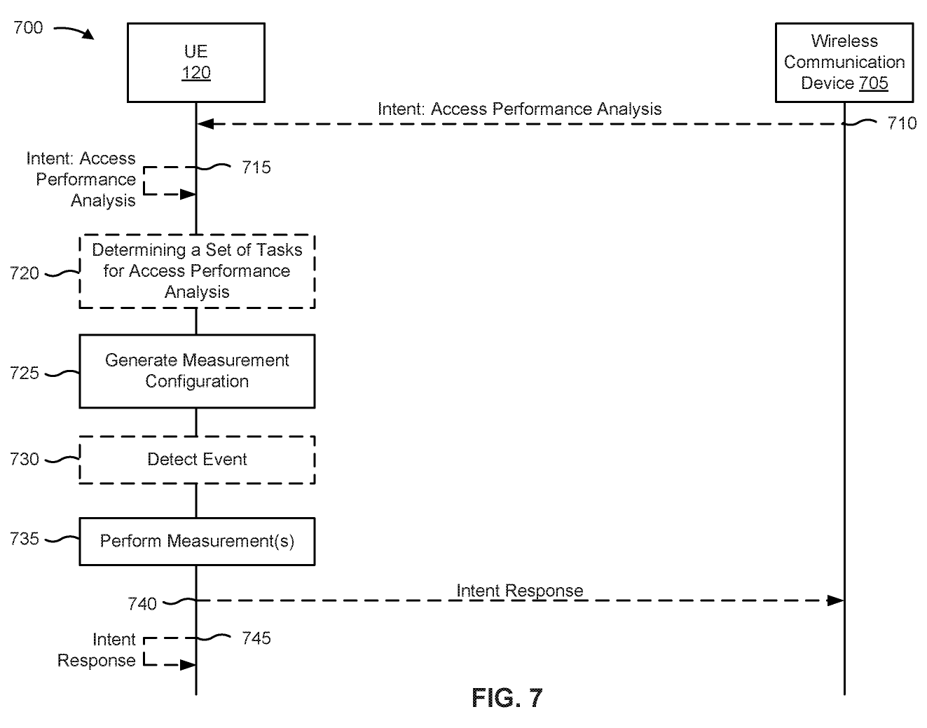

For example, the intent may include a request for information associated with a network performance analysis (e.g., the intent may include a request for the UE 120 to analyze the network performance and provide information related to the analysis). In another example, the intent may include a request for information associated with a network inefficiencies analysis (e.g., the intent may include a request for the UE 120 to determine network inefficiencies and provide information related to the determination). In another example, and as described in more detail with respect to FIG. 5 , the intent may include a request for information associated with a beam management performance analysis (e.g., the intent may include a request for the UE 120 to analyze the beam management performance and provide information related to the analysis). In another example, and as described in more detail with respect to FIG. 6 , the intent may include a request for information associated with a mobility management performance analysis (e.g., the intent may include a request for the UE 120 to analyze the mobility management performance and provide information related to the analysis). In another example, and as described in more detail with respect to FIG. 7 , the intent may include a request for information associated with an access performance analysis (e.g., the intent may include a request for the UE 120 to analyze the access performance and provide information related to the analysis).

As shown by reference number 415, if the UE 120 does not receive the intent the wireless communication device 405, the UE 120 may instead receive the intent from another component of the UE 120. Here, an AI component (e.g., the AI component 215 as described with reference to FIG. 2 ) at the UE 120 may receive the intent from another component at the UE 120. Here, the other component may be an application at the UE 120, a different AI component at the UE 120, or a protocol layer (e.g., that is distinct from or different from the AI component 215) at a modem of the UE 120.

As shown by reference number 420, the UE 120 may optionally determine, based on the intent, a set of tasks associated with the intent. The set of tasks may correspond to more specific intents that are associated with the intent. That is, the UE 120 may determine different, more specific, intents that are associated with the configured intent (e.g., the intent that is received from another wireless communication device 405 or another component of the UE 120).

The UE 120 may determine the set of tasks associated with the intent based on contextual information associated with the UE 120. That is, the UE 120 may use the contextual information associated with the UE 120 to determine the set of tasks. Contextual information associated with the UE 120 may include the speed and environment of the UE 120, such as whether the UE 120 is in a car or with a user that is walking. In another example, surrounding information like the UE 120 being in a stadium, park, home, or workplace may be considered as contextual information. Additionally, crowd-sourced information, such as events, festivals, or celebrations, can serve as contextual information for the UE 120. Furthermore, the capabilities of the UE 120, including communication, sensing, computing, and applications, are also examples of contextual information.

In one example, if the UE 120 receives an intent that includes a request for the UE 120 to analyze access performance, the UE 120 may determine a set of tasks that includes a performance associated with different connection types (e.g., including identifying coverage holes in a radio access technology (RAT) or in a combination of RATs) analysis task, a performance associated with different services analysis task (e.g., including performing quality of service (QoS) related analysis tasks or analyzing the performance of the UE 120 during a handover), a performance associated with access analysis task (e.g., including random access channel (RACH) analysis, including an uplink and downlink imbalance analysis), and a performance during mobility analysis task (e.g., including a connected state mobility performance analysis, including a non-connected state mobility performance analysis). In this way, determining specific tasks allows the UE to systematically address various aspects of network performance.

As shown by reference number 425, the UE 120 may transmit, to the wireless communication device 405 (which may correspond to a network entity), signaling indicating the set of tasks associated with the intent.

As shown by reference number 430, the UE 120 may receive, from the wireless communication device 405 (which may correspond to a network entity), an indication of one or more of the tasks in the set of tasks. That is, the wireless communication device 405 may indicate for the UE 120 to obtain the information corresponding to the one or more tasks. For example, a network entity may instruct the UE 120 to prioritize collecting information associated with one of the tasks in the set, which may optimize the UEs 120 data gathering efforts to focus on critical performance metrics.

In some cases, the UE 120 may rely on connection context information to perform intent-driven measurement collection and reporting. A connection context may correspond to a characteristic, feature, or parameter associated with one or more communications performed by the UE 120. For example, a connection context may include an area scope associated with communications performed by the UE 120, such as specific frequencies, cells, tracking area codes (TACs), public land mobile networks (PLMNs), private networks (PNs), or non-public networks (NPNs). In another example, the connection context may include time-related factors, like specific time ranges for data collection. The environment, whether indoor or outdoor, may also serves as a connection context (e.g., the connection context may correspond to communications performed by the UE 120 while the UE 120 is indoors or communications performed by the UE 120 while the UE 120 is outdoors). Additionally, a speed of the UE 120, (e.g., whether the UE 120 is stationary, moving with a pedestrian, in a car, above a high-speed threshold, or operating as a UAV may correspond to a connection context).

In some cases, the intent may include connection context information. That is, the intent may include an indication of one or more connection contexts associated with the intent. Here, the UE 120 may refrain from the transmitting and receiving actions shown and described by reference number 435 and reference number 440. In some other cases, the UE 120 may perform the intent-driven measurement collection and reporting on a per-connection-context-basis (and not for a configured or negotiated subset of the connection contexts). Here, the UE 120 may also refrain from the transmitting and receiving actions shown and described by reference number 435 and reference number 440.

In some other cases, the UE 120 may negotiate a subset of connection contexts for the intent (e.g., with a network entity, with the wireless communication device 405). In these cases, and as shown by reference number 435, the UE 120 may transmit, and the wireless communication device 405 may receive, signaling indicative of one or more connection contexts associated with the intent.

Then, and as shown by reference number 440, the wireless communication device 405 may transmit, and the UE 120 may receive, an indication of one connection context. Here, the UE 120 may perform the intent-driven measurement collection and reporting for the indicated one connection context (e.g., instead of the plurality of connection contexts indicated by the UE 120). In this way, the other wireless communication device 405 may help the UE 120 refine the data collection configuration for the intent. from the plurality of connection contexts. For example, the UE could report connection contexts like different frequency bands or cell environments to a network entity. In this way, sharing connection context information supports more targeted measurement configurations.

While not illustrated in FIG. 4, the UE 120 may also negotiate one or more other aspects of the intent-driven measurement collection and reporting with the wireless communication device 405. For example, the UE 120 may negotiate measurement configurations with the other wireless communication device 405. For example, the UE 120 may propose, to the wireless communication device 405, specific measurements or measurement configurations, engaging in a negotiation process with the wireless communication device 405, to finalize optimal configurations for performing measurements to obtain information associated with the intent (e.g., the information requested by the intent). Such negotiations may enable the UE 120 to tailor the configuration to better suit current network conditions.

As shown by reference number 445, the UE 120 may generate a configuration for one or more measurements to obtain the information requested by the intent. The configuration may indicate one or more measurements for the UE 120 to perform (e.g., an application layer measurement, a signal quality measurement, a performance measurement, a sensor measurement). Specifying measurements in the configuration ensures that data collection aligns with the intended analysis. Additionally, or alternatively, the configuration may indicate a periodicity for performing the one or more measurements, or one or more events associated with triggering the UE 120 to perform the one or more measurements. For example, the UE 120 may schedule measurements to be performed every minute or when the UE 120 detects a significant change in location of the UE 120 is detected. Defining periodicity or events for measurements may optimize resource usage and timing for data collection.

In some cases, the UE 120 may generate the configuration based on contextual information associated with the UE 120. That is, the UE 120 may use the contextual information associated with the UE 120 to generate the configuration. In some cases, leveraging contextual information to generate the configuration may enhance the relevance and accuracy of the one or more measurements obtaining information requested by the intent. The contextual information may correspond to information associated with the UE 120 (and associated with communications at the UE 120). For example, the contextual information may include a location of the UE 120, signal metrics associated with communications at the UE 120 (e.g., signal-to-noise ratio (SNR), reference signal received power (RSRP), or reference signal received quality (RSRQ)), uplink queue sizes and the history of uplink and downlink grants, power headroom at the UE 120, sensing or positioning data associated with the UE 120, or an energy impact of communications or running applications.

In some cases, the UE 120 may generate the configuration for the one or more measurements based on the set of tasks associated with the intent. For example, the UE 120 may generate the configuration to obtain information corresponding to at least one of the set of tasks. If the wireless communication device 405 indicates one or more tasks for the set of tasks, the UE 120 may generate the configuration for one or more measurements that obtain information associated with the indicated one or more tasks.

The UE 120 may generate the configuration using an AI component at the UE 120. Here, the UE 120 may provide, to the AI component, the intent and the contextual information associated with the UE 120 to the AI component and the AI component may output (e.g., generate) the configuration for the one or more measurements.

As shown by reference number 450, the UE 120 may detect at least one event from the one or more events associated with triggering the UE 120 to perform the one or more measurements. That is, if the configuration indicates one or more events associated with triggering the UE 120 to perform the one or more measurements, the UE 120 may monitor for the one or more events. For example, the configuration may indicate for the UE 120 to perform a measurement when there is an initiation of a service (e.g., voice, data, XR, or gaming service). In another example, the configuration may indicate for the UE 120 to perform a measurement based on (or responsive to) a type of connectivity being established (e.g., long-term evolution (LTE), NR, NTN, or high-speed train network (HSTN) connectivity). Additionally, or alternatively, the configuration may indicate for the UE 120 to perform a measurement upon detection of network issues, such as coverage gaps, high ping-pong frequencies, or RLFs. Furthermore, the configuration may indicate for the UE 120 to perform a measurement based on (or responsive to) detecting that the UE 120 is in a specific location or service area.

When the UE 120 detects the at least one event associated with triggering the UE 120 to perform the one or more measurements, the UE 120 may perform the one or more measurements (e.g., as described with reference to reference number 455).

As shown by reference number 455, the UE 120 may perform, based on the configuration, the one or more measurements associated with the intent. That is, the UE 120 may perform the one or more measurements in accordance with the configuration. For example, the UE 120 may perform one or more application layer measurements (e.g., playback delay or jitter measurements to assess the QoS for applications running on the UE 120). Additionally, or alternatively, the UE 120 may perform one or more radio measurements (e.g., including an L1 and layer 3 (L3) RSRP, RSRQ, Signal-to-Interference-plus-Noise Ratio (SINR), CSI, or cross-link interference (CLI) measurements). Additionally, or alternatively, the UE 120 may perform one or more performance metric measurements (e.g., to determine throughput, packet delay, and packet drop rates). In some other examples, the UE 120, as part of performing the one or more measurements, may gather data on application response times or battery usage during data collection. Executing the configured measurements may allow the UE 120 to systematically gather data required for the analysis indicated or requested by the intent.

In some aspects, the UE 120 may continuously monitor and adjust the data collection process based on evolving network conditions or intent fulfillment. For example, the UE 120 may assess collected data on network latency and dynamically adjust measurement configurations to better align with real-time network performance needs. Continuous adjustment may ensure that the UE 120 remains responsive to changing conditions and optimizes data collection efforts.

In some aspects, the one or more measurements may obtain information associated with one connection context from a plurality of connection contexts (e.g., in accordance with the configuration). For example, the UE 120 may focus on data gathering in an indoor environment while ignoring outdoor signal variations. Focusing on specific connection contexts may enhance the relevance of collected data. In some other examples, the one or more measurements may obtain information associated with a plurality of the connection contexts. For example, the configuration may indicate for the UE 120 to perform one or more measurements that obtain information (e.g., performance metrics) across multiple cell towers within a specified time frame. Covering multiple connection contexts allows for a robust analysis of network conditions.

In some cases, the UE 120 may generate a plurality of configurations for a plurality of connection contexts. Here, the UE 120 may perform the one or more measurements on a per-connection-context basis. That is, each of the plurality of configurations may be associated with one connection context, and the UE 120 may perform a plurality of one or more measurements that each obtain information associated with one of the connection contexts.

As shown by reference number 460, the UE 120 may transmit, to the wireless communication device 405, an intent response. The intent response may include an indication of the one or more measurements. The UE 120 may transmit the intent response (e.g., to another wireless communication device 405) if a consumer of the intent-driven data (e.g., of the intent response) is another wireless communication device 405 (e.g., a network entity or another UE).

In some other cases, and as shown by reference number 465, the UE 120 may provide, to another component of the UE 120, the intent response (e.g., the indication of the one or more measurements). The UE 120 may provide the intent response to another component within the UE 120 if the consumer of the intent-driven data (e.g., of the intent response) is internal to the UE 120 (e.g., an application at the UE 120, another AI component at the UE 120, or a protocol layer at a modem of the UE 120).

The intent response may include the information that is associated with the intent. For example, the intent response may include an indication of the one or more measurements. Additionally, or alternatively, the intent response may include an indication of one or more events associated with the one or more measurements (e.g., events that triggered the UE 120 to perform the measurements).

FIG. 4 is provided as an example. Other examples may differ from what is described with regard to FIG. 4.

FIG. 5 is a diagram of an example 500 associated with techniques for measurement configuration generation based on an intent. As shown in FIG. 5, a UE 120 and another wireless communication device 505 may communicate with one another. The UE 120 may correspond to the UE 120 described with reference to FIGS. 1-4. For example, the UE 120 may include an AI component and the UE 120 may be capable of performing intent-driven measurement collection and reporting. The wireless communication device 505 may correspond to a network entity, another UE, a server associated with an application at the UE 120, an application server associated with a network entity, a RAN node, a network function, or a network server.

The example 500 may be an example of the UE 120 performing intent-driven measurement collection and reporting for an intent that includes a request for the UE 120 to perform beam management performance analysis.

As shown by reference number 510, the UE 120 may optionally receive an intent from the wireless communication device 505.

As shown by reference number 515, if the UE 120 does not receive the intent the wireless communication device 505, the UE 120 may instead receive the intent from another component of the UE. Here, an AI component (e.g., the AI component 215 as described with reference to FIG. 2) at the UE 120 may receive the intent from another component at the UE 120. Here, the other component may be an application at the UE 120, a different AI component at the UE 120, or a protocol layer (e.g., that is distinct from or different from the AI component 215) at a modem of the UE 120.

In both cases (e.g., if the UE 120 receives the intent from the wireless communication device or from a component within the UE 120), the intent may include a request for information associated with communications at the UE 120. In particular, the intent may correspond to beam performance analysis. That is, the intent may include a request for the UE 120 to provide information associated with beam performance analysis.

As shown by reference number 520, the UE 120 may optionally determine a set of tasks associated with the intent (e.g., associated with beam management performance analysis). The set of tasks may correspond to more specific intents (e.g., that are associated with the beam performance analysist intent).

For example, the UE 120 may determine, based on receiving a beam management performance analysis intent, a set of tasks (or more specific, less general, more targeted intents) that may generate information associated with beam management performance analysis. As an example, the UE 120 may determine a set of tasks that include a beam coverage analysis task, a beam capacity analysis task, an AI or ML beam management performance analysis task, a beam switching performance analysis task, an AI or ML beam switching performance analysis task, a beam failure recovery performance analysis task, a beam failure cause analysis task, or a beam failure during a lower-layer triggered mobility procedure analysis task.

In some cases, and while not illustrated in FIG. 5, the UE 120 may indicate, to a network entity, the set of tasks associated with the beam management performance analysis intent. The network entity may then indicate a subset of the set of tasks. The UE 120 may then generate a configuration for one or more measurements to generate information associated with the subset of the set of tasks indicated to the UE 120 by the network entity.

As shown by reference number 525, the UE 120 may generate a configuration for one or more measurements to obtain the information associated with the intent of beam management performance analysis.

The configuration may indicate one or more measurements for the UE 120 to perform to obtain information associated with beam management performance analysis. For example, the configuration may indicate for the UE 120 obtain cell information, beam information, L1 beam measurement information, L3 beam measurement information, MAC layer information (e.g., hybrid automatic repeat request (HARQ) acknowledgement (ACK) distribution information, timing advance information, transmission configuration indictor information), beam failure cause information, beam failure rate information, beam switching delay information, location information associated with the UE 120, QoS measurement information associated with a beam (e.g., throughout information for the beam, latency information for the beam, packet drop information for the beam), or QoS measurement information associated with beam switching (e.g., throughout information during beam switching, latency information during beam switching, packet drop information during beam switching).

The UE 120 may generate the configuration based on contextual information associated with the UE 120 or based on a connection context. For example, the UE 120 may generate a configuration for one or more measurements to obtain information associated with beam management performance analysis for a connection context, a connection type (e.g., a type of established connection), or a type of service. In some cases, the UE 120 may generate a plurality of configurations that are each associated with a different connection context.

In one example, the configuration may indicate one or more measurements to obtain information associated with one connection context. The connection context may correspond to a specific area scope (e.g., to a specific set of frequencies, to one or more cells, to a TAC), to a specific PLMN, a specific PN, a specific NPN, a specific time or time range, a specific environment (e.g., an indoor environment or an outdoor environment), or a specific speed or range of speeds of the UE 120 (e.g., corresponding to a pedestrian speed, a car speed, a speed threshold, a high speed train speed, a UAV speed). Additionally, or alternatively, the connection context may correspond to a specific type of established connection (e.g., to a terrestrial network, to an NTN, to a specific type of RAN, or an unlicensed spectrum connection). In some other examples, the connection context may correspond to a type of service (e.g., to a data service, a voice service, a streaming service, a sensing service, a gaming service, an AI service, an XR service, or a green service).

The configuration may indicate for the UE 120 to perform the one or more measurements periodically (e.g., a periodic trigger). Additionally, or alternatively, the configuration may indicate one or more events associated with triggering the UE 120 to perform the one or more measurements. The one or more events may include a change in the contextual information associated with the UE 120, a quality of experience at the UE 120 that fails to satisfy a threshold, the UE 120 detecting a coverage hole at the UE 120, the UE 120 detecting a low capacity at the UE 120 (or detecting other capacity issues such las low throughput or high delay), or the UE 120 detecting a failure event (e.g., a beam failure, a lower-layer triggered mobility procedure failure).

As shown by reference number 530, the UE 120 may optionally detect one or more events associated with triggering the UE 120 to perform the one or more measurements. That is, if there are events associated with triggering the UE 120 to perform the one or more measurements, the UE 120 may detect the one or more events associated with triggering the UE 120 to perform the one or more measurements. When the UE 120 detects the at least one event associated with triggering the UE 120 to perform the one or more measurements, the UE 120 may perform the one or more measurements (e.g., as described with reference to reference number 535).

As shown by reference number 535, the UE 120 may perform, based on the configuration, the one or more measurements associated with beam management performance analysis.

As shown by reference number 540, the UE 120 may transmit, to the wireless communication device 505, an intent response. The intent response may include an indication of the one or more measurements. The UE 120 may transmit the intent response (e.g., to another wireless communication device 505) if a consumer of the intent-driven data (e.g., of the intent response) is another wireless communication device 505 (e.g., a network entity or another UE).

In some other cases, and as shown by reference number 545, the UE 120 may provide, to another component of the UE 120, the intent response (e.g., the indication of the one or more measurements). The UE 120 may provide the intent response to another component within the UE 120 if the consumer of the intent-driven data (e.g., of the intent response) is internal to the UE 120 (e.g., an application at the UE 120, another AI component at the UE 120, or a protocol layer at a modem of the UE 120).

The intent response may include the information associated with beam management performance analysis. For example, the intent response may include an indication of the one or more measurements (e.g., one or more application layer measurements, one or more radio measurements, one or more sensor measurements).

FIG. 5 is provided as an example. Other examples may differ from what is described with regard to FIG. 5.

FIG. 6 is a diagram of an example 600 associated with techniques for measurement configuration generation based on an intent. As shown in FIG. 6, a UE 120 and another wireless communication device 605 may communicate with one another. The UE 120 may correspond to the UE 120 described with reference to FIGS. 1-5. For example, the UE 120 may include an AI component and the UE 120 may be capable of performing intent-driven measurement collection and reporting. The wireless communication device 605 may correspond to a network entity, another UE, a server associated with an application at the UE 120, an application server associated with a network entity, a RAN node, a network function, or a network server.

The example 600 may be an example of the UE 120 performing intent-driven measurement collection and reporting for an intent that includes a request for the UE 120 to perform mobility management performance analysis.

As shown by reference number 610, the UE 120 may optionally receive, and the wireless communication device 605 may transmit, an intent.

As shown by reference number 615, if the UE 120 does not receive the intent the wireless communication device 605, the UE 120 may instead receive the intent from another component of the UE. Here, an AI component (e.g., the AI component 215 as described with reference to FIG. 2) at the UE 120 may receive the intent from another component at the UE 120. Here, the other component may be an application at the UE 120, a different AI component at the UE 120, or a protocol layer (e.g., that is distinct from or different from the AI component 215) at a modem of the UE 120.

In both cases (e.g., if the UE 120 receives the intent from the wireless communication device or from a component within the UE 120), the intent may include a request for information associated with communications at the UE 120. In particular, the intent may correspond to mobility management performance analysis. That is, the intent may include a request for the UE 120 to provide information associated with mobility management performance analysis.

As shown by reference number 620, the UE 120 may optionally determine a set of tasks associated with the intent (e.g., associated with mobility management performance analysis). The set of tasks may correspond to more specific intents (e.g., that are associated with the beam performance analysist intent).

For example, the UE 120 may determine, based on receiving a mobility management performance analysis intent, a set of tasks (or more specific, less general, more targeted intents) that may generate information associated with mobility management performance analysis. As an example, the UE 120 may determine a set of tasks that include a coverage weakness analysis task, a capacity weakness analysis task, an AI or ML mobility management performance analysis task, a ping-pong rate analysis task, an early handover failure analysis task, a late handover failure analysis task, a wrong cell handover analysis task, an RLF cause analysis task, a suitable cell selection analysis task, a multi-connectivity performance analysis task, or a cell selection and reselection performance analysis task.

In some cases, and while not illustrated in FIG. 6, the UE 120 may indicate, to a network entity, the set of tasks associated with the mobility management performance analysis intent. The network entity may then indicate a subset of the set of tasks. The UE 120 may generate a configuration for one or more measurements to generate information associated with the subset of the set of tasks indicated to the UE 120 by the network entity.

As shown by reference number 625, the UE 120 may generate a configuration for one or more measurements to obtain the information associated with the intent of mobility management performance analysis.

The configuration may indicate one or more measurements for the UE 120 to perform to obtain information associated with mobility management performance analysis. For example, the configuration may indicate for the UE 120 obtain cell information, beam information, L1 beam measurement information, L3 beam measurement information, or radio link management information (e.g., information associated with radio link management issues such as information associated with Q outor Q in). Additionally, or alternatively, the configuration may indicate for the UE 120 to obtain MAC layer information, such as HARQ ACK distribution information, timing advance information, transmission configuration indictor information. The configuration may indicate for the UE 120 to obtain handover rate information (e.g., that includes cell information and a handover type information associated with the handover rate information) or ping-pong rate information (e.g., that includes cell information and a handover type associated with the ping-pong rate).

In some cases, the configuration may indicate for the UE 120 to obtain trajectory information, including cell information, timing information (e.g., a window of arrival, an expected and measured time spent), or cell RRC information associated with the trajectory information. The configuration may indicate for the UE 120 to obtain handover failure or RLF information, including the rates, causes, cell information, and handover type associated with the failure. The configuration may indicate for the UE 120 to obtain cell selection information (e.g., cell selection or cell reselection rates associated with a cell information and a handover time), time information (e.g., interruption time, time spent on a cell, time since failure, time until reconnection) associated with a cell or handover type, location information (e.g., GNSS information of the UE 120, a velocity of the UE 120, an altitude of the UE 120, WiFi or Bluetooth location information), QoS measurement information associated with a beam (e.g., throughout information for the beam, latency information for the beam, packet drop information for the beam), or QoS measurement information associated with beam switching (e.g., throughout information during beam switching, latency information during beam switching, packet drop information during beam switching).

The UE 120 may generate the configuration based on contextual information associated with the UE 120 or based on a connection context. For example, the UE 120 may generate a configuration for one or more measurements to obtain information associated with mobility management performance analysis for a connection context, a connection type (e.g., a type of established connection), or a type of service. In some cases, the UE 120 may generate a plurality of configurations that are each associated with a different connection context.

In one example, the configuration may indicate one or more measurements to obtain information associated with one connection context. The connection context may correspond to a specific area scope (e.g., to a specific set of frequencies, to one or more cells, to a TAC), to a specific PLMN, a specific PN, a specific NPN, a specific time or time range, a specific operating environment (e.g., an indoor environment or an outdoor environment), or a specific speed or range of speeds of the UE 120 (e.g., corresponding to a pedestrian speed, a car speed, a speed threshold, a high speed train speed, a UAV speed). Additionally, or alternatively, the connection context may correspond to a specific type of established connection (e.g., to a terrestrial network, to an NTN, to a specific type of RAN, or an unlicensed spectrum connection). In some other examples, the connection context may correspond to a type of service (e.g., to a data service, a voice service, a streaming service, a sensing service, a gaming service, an AI service, an XR service, or a green service) during a handover or when the UE 120 is connected to a certain beam or cell.

In some cases, the connection context may correspond to a type of handover type for connected state mobility (e.g., a classical handover, a dual active protocol stack (DAPS) handover, a conditional handover, a primary serving cell handover, a master handover request (MHR) handover, a secondary handover request (SHR) handover, a conditional primary serving cell addition or change handover, a voice fallback handover, a master cell group recovery handover, an inter-RAT handover, or a lower-layer triggered mobility procedure). Additionally, or alternatively, the connection context may correspond to the mobility performance of the UE 120 during a standalone mode or during a multi-connectivity mode. In some other cases, the connection context may correspond to a connectivity state of the UE 120 (e.g., the UE 120 being in an idle or inactive state mobility mode).

The configuration may indicate for the UE 120 to perform the one or more measurements periodically (e.g., a periodic trigger). Additionally, or alternatively, the configuration may indicate one or more events associated with triggering the UE 120 to perform the one or more measurements. The one or more events may include a change in the contextual information at the UE 120, a quality of experience at the UE 120 that fails to satisfy a threshold, the UE 120 detecting a coverage hole at the UE 120, the UE 120 detecting a low capacity at the UE 120, the UE 120 detecting a failure event, a switch from standalone connectivity to multi-connectivity, an addition of a secondary cell, or a cell group failure (e.g., a master cell group failure, a secondary cell group failure).

As shown by reference number 630, the UE 120 may optionally detect one or more events associated with triggering the UE 120 to perform the one or more measurements. That is, if there are events associated with triggering the UE 120 to perform the one or more measurements, the UE 120 may detect the one or more events associated with triggering the UE 120 to perform the one or more measurements. When the UE 120 detects the at least one event associated with triggering the UE 120 to perform the one or more measurements, the UE 120 may perform the one or more measurements (e.g., as described with reference to reference number 635).

As shown by reference number 635, the UE 120 may perform, based on the configuration, the one or more measurements associated with mobility management performance analysis.

As shown by reference number 640, the UE 120 may transmit, to the wireless communication device 605, an intent response. The intent response may include an indication of the one or more measurements. The UE 120 may transmit the intent response (e.g., to another wireless communication device 605) if a consumer of the intent-driven data (e.g., of the intent response) is another wireless communication device 605 (e.g., a network entity or another UE).

In some other cases, and as shown by reference number 645, the UE 120 may provide, to another component of the UE 120, the intent response (e.g., the indication of the one or more measurements). The UE 120 may provide the intent response to another component within the UE 120 if the consumer of the intent-driven data (e.g., of the intent response) is internal to the UE 120 (e.g., an application at the UE 120, another AI component at the UE 120, or a protocol layer at a modem of the UE 120).

The intent response may include the information associated with mobility management performance analysis. For example, the intent response may include an indication of the one or more measurements (e.g., one or more application layer measurements, one or more radio measurements, one or more sensor measurements).

FIG. 6 is provided as an example. Other examples may differ from what is described with regard to FIG. 6.

FIG. 7 is a diagram of an example 700 associated with techniques for measurement configuration generation based on an intent. As shown in FIG. 7, a UE 120 and another wireless communication device 705 may communicate with one another. The UE 120 may correspond to the UE 120 described with reference to FIGS. 1-6. For example, the UE 120 may include an AI component and the UE 120 may be capable of performing intent-driven measurement collection and reporting. The wireless communication device 705 may correspond to a network entity, another UE, a server associated with an application at the UE 120, an application server associated with a network entity, a RAN node, a network function, or a network server.

The example 700 may be an example of the UE 120 performing intent-driven measurement collection and reporting for an intent that includes a request for the UE 120 to perform access performance analysis.

As shown by reference number 710, the UE 120 may optionally receive, and the wireless communication device 705 may transmit, an intent.

As shown by reference number 715, if the UE 120 does not receive the intent the wireless communication device 705, the UE 120 may instead receive the intent from another component of the UE. Here, an AI component (e.g., the AI component 215 as described with reference to FIG. 2) at the UE 120 may receive the intent from another component at the UE 120. Here, the other component may be an application at the UE 120, a different AI component at the UE 120, or a protocol layer (e.g., that is distinct from or different from the AI component 215) at a modem of the UE 120.

In both cases (e.g., if the UE 120 receives the intent from the wireless communication device or from a component within the UE 120), the intent may include a request for information associated with communications at the UE 120. In particular, the intent may correspond to access performance analysis. That is, the intent may include a request for the UE 120 to provide information associated with access performance analysis.

As shown by reference number 720, the UE 120 may optionally determine a set of tasks associated with the intent (e.g., associated with access performance analysis). The set of tasks may correspond to more specific intents (e.g., that are associated with the beam performance analysist intent).

For example, the UE 120 may determine, based on receiving a access performance analysis intent, a set of tasks (or more specific, less general, more targeted intents) that may generate information associated with access performance analysis. As an example, the UE 120 may determine a set of tasks that include a random access channel analysis task (e.g., a feature or feature group-specific random access channel analysis task), a random access channel resource assignment analysis task, or a power ramping algorithm analysis task.

In some cases, and while not illustrated in FIG. 7, the UE 120 may indicate, to a network entity, the set of tasks associated with the access performance analysis intent. The network entity may then indicate a subset of the set of tasks. The UE 120 may generate a configuration for one or more measurements to generate information associated with the subset of the set of tasks indicated to the UE 120 by the network entity.

As shown by reference number 725, the UE 120 may generate a configuration for one or more measurements to obtain the information associated with the intent of access performance analysis.

The configuration may indicate one or more measurements for the UE 120 to perform to obtain information associated with access performance analysis. For example, the configuration may indicate for the UE 120 to obtain information associated with a purpose for the UE 120 performing a random access channel procedure, cell information, beam information, L1 beam measurement information, L3 beam measurement information, information associated with resources for the UE 120 performing the random access channel procedure (e.g., including partitioning information), MAC layer information (e.g., HARQ ACK distribution information, timing advance information, transmission configuration indictor information), random access channel procedure failure information, service information (e.g., small data transmission information), time information (e.g., associated with the UE 120 performing an access procedure), or location information (e.g., associated with the UE 120 performing an access procedure).

The UE 120 may generate the configuration based on contextual information associated with the UE 120 or based on a connection context. For example, the UE 120 may generate a configuration for one or more measurements to obtain information associated with access performance analysis for a connection context, a connection type (e.g., a type of established connection), or a type of service. In some cases, the UE 120 may generate a plurality of configurations that are each associated with a different connection context.

In one example, the configuration may indicate one or more measurements to obtain information associated with one connection context. The connection context may correspond to a specific area scope (e.g., to a specific set of frequencies, to one or more cells, to a TAC), to a specific PLMN, a specific PN, a specific NPN, a specific time or time range, a specific operating environment (e.g., an indoor environment or an outdoor environment), or a specific speed or range of speeds of the UE 120 (e.g., corresponding to a pedestrian speed, a car speed, a speed threshold, a high speed train speed, a UAV speed). Additionally, or alternatively, the connection context may correspond to a specific type of established connection (e.g., to a terrestrial network, to an NTN, to a specific type of RAN, or an unlicensed spectrum connection). In some other examples, the connection context may correspond to a type of service (e.g., to a data service, a voice service, a streaming service, a sensing service, a gaming service, an AI service, an XR service, or a green service) during a handover or when the UE 120 is connected to a certain beam or cell. In some cases, the connection context may correspond to a type of service for a feature (e.g., small data transmission) associated with access procedures or a type of access procedure (e.g., a 4-step random access channel procedure, a 2-step random access channel procedure, a handover procedure where connection establishment fail reports are enabled, on demand system information access procedures, or uplink or downlink coverage access procedures).

The configuration may indicate for the UE 120 to perform the one or more measurements periodically (e.g., a periodic trigger). Additionally, or alternatively, the configuration may indicate one or more events associated with triggering the UE 120 to perform the one or more measurements. The one or more events may include a success or failure of a random access channel procedure, a feature-specific random access channel procedure being triggered, a feature associated with access procedures being initialized (e.g., small data transmissions being initialized), or the UE 120 switching from performing a first type of access procedure to performing a second type of access procedure (e.g., the UE 120 switching from performing random access channel-less based access procedures to performing random access channel based procedures).

As shown by reference number 730, the UE 120 may optionally detect one or more events associated with triggering the UE 120 to perform the one or more measurements. That is, if there are events associated with triggering the UE 120 to perform the one or more measurements, the UE 120 may detect the one or more events associated with triggering the UE 120 to perform the one or more measurements. When the UE 120 detects the at least one event associated with triggering the UE 120 to perform the one or more measurements, the UE 120 may perform the one or more measurements (e.g., as described with reference to reference number 735).

As shown by reference number 735, the UE 120 may perform, based on the configuration, the one or more measurements associated with access performance analysis.

As shown by reference number 740, the UE 120 may transmit, to the wireless communication device 705, an intent response. The intent response may include an indication of the one or more measurements. The UE 120 may transmit the intent response (e.g., to another wireless communication device 705) if a consumer of the intent-driven data (e.g., of the intent response) is another wireless communication device 705 (e.g., a network entity or another UE).

In some other cases, and as shown by reference number 745, the UE 120 may provide, to another component of the UE 120, the intent response (e.g., the indication of the one or more measurements). The UE 120 may provide the intent response to another component within the UE 120 if the consumer of the intent-driven data (e.g., of the intent response) is internal to the UE 120 (e.g., an application at the UE 120, another AI component at the UE 120, or a protocol layer at a modem of the UE 120).

The intent response may include the information associated with access performance analysis. For example, the intent response may include an indication of the one or more measurements (e.g., one or more application layer measurements, one or more radio measurements, one or more sensor measurements).

FIG. 7 is provided as an example. Other examples may differ from what is described with regard to FIG. 7.

FIG. 8 is a diagram illustrating an example process 800 performed, for example, at a UE or an apparatus of a UE. Example process 800 is an example where the apparatus or the UE (e.g., UE 120) performs operations associated with techniques for measurement configuration based on an intent.

As shown in FIG. 8, in some aspects, process 800 may include receiving an intent comprising a request for information associated with communications at the UE (block 810). For example, the UE (e.g., using reception component 902 or communication manager 906, depicted in FIG. 9) may receive an intent comprising a request for information associated with communications at the UE, as described above.

As further shown in FIG. 8, in some aspects, process 800 may include generating, based at least in part on contextual information associated with the UE, a configuration for one or more measurements to obtain the information requested by the intent (block 820). For example, the UE (e.g., using communication manager 906, depicted in FIG. 9) may generate, based at least in part on contextual information associated with the UE, a configuration for one or more measurements to obtain the information requested by the intent, as described above.

As further shown in FIG. 8, in some aspects, process 800 may include performing, based at least in part on the configuration and to obtain the information requested by the intent, the one or more measurements associated with the intent (block 830). For example, the UE (e.g., using communication manager 906, depicted in FIG. 9) may perform, based at least in part on the configuration and to obtain the information requested by the intent, the one or more measurements associated with the intent, as described above.

As further shown in FIG. 8, in some aspects, process 800 may include providing an indication of the one or more measurements (block 840). For example, the UE (e.g., using communication manager 906, depicted in FIG. 9) may provide an indication of the one or more measurements, as described above.

Process 800 may include additional aspects, such as any single aspect or any combination of aspects described below or in connection with one or more other processes described elsewhere herein.

In a first aspect, the contextual information comprises a speed of the UE, a location of the UE, capability information associated with the UE, or information associated with the location of the UE.

In a second aspect, alone or in combination with the first aspect, the one or more measurements comprise one or more application layer measurements, one or more signal quality measurements, one or more performance measurements, or one or more sensor measurements.

In a third aspect, alone or in combination with one or more of the first and second aspects, receiving the intent comprises receiving, by an AI component at the UE, the intent from another wireless communication device, wherein the other wireless communication device comprises a network entity, a second UE, a server associated with an application at the UE, an application server associated with a network entity, a RAN node, a network function, or a network server.

In a fourth aspect, alone or in combination with one or more of the first through third aspects, receiving the intent comprises receiving the intent from another component of the UE, wherein the other component comprises an application at the UE, a second AI component at the UE, or a protocol layer at a modem of the UE.

In a fifth aspect, alone or in combination with one or more of the first through fourth aspects, the configuration indicates the one or more measurements for the UE to perform.

In a sixth aspect, alone or in combination with one or more of the first through fifth aspects, the configuration indicates a periodicity for performing the one or more measurements, or one or more events associated with triggering the UE to perform the one or more measurements.

In a seventh aspect, alone or in combination with one or more of the first through sixth aspects, the configuration indicates the one or more events associated with triggering the UE to perform the one or more measurements, and process 800 includes detecting at least one event from the one or more events associated with triggering the UE to perform the one or more measurements.

In an eighth aspect, alone or in combination with one or more of the first through seventh aspects, process 800 includes determining, based at least in part on the intent, a plurality of tasks associated with the intent, wherein the configuration for the one or more measurements is based at least in part on the one or more measurements obtaining the information corresponding to at least one of the plurality of tasks.

In a ninth aspect, alone or in combination with one or more of the first through eighth aspects, process 800 includes transmitting, to a network entity, signaling indicating the plurality of tasks associated with the intent, and receiving, from the network entity, an indication to obtain the information corresponding to the at least one of the plurality of tasks indicated by the UE, wherein generating the configuration is based at least in part on receiving the indication.

In a tenth aspect, alone or in combination with one or more of the first through ninth aspects, the one or more measurements obtain information associated with one connection context from a plurality of connection contexts.

In an eleventh aspect, alone or in combination with one or more of the first through tenth aspects, the plurality of connection contexts comprise a set of frequencies, one or more cells, a TAC, a PLMN, a PN, an NPN, a time range, an operating environment of the UE, or a range of speeds of the UE.

In a twelfth aspect, alone or in combination with one or more of the first through eleventh aspects, the intent further comprises an indication of the one connection context.

In a thirteenth aspect, alone or in combination with one or more of the first through twelfth aspects, process 800 includes generating, based at least in part on the contextual information associated with the UE, one or more additional configurations for one or more additional measurements to obtain additional information requested by the intent, wherein the one or more additional configurations are each associated with obtaining the additional information associated with a different connection context from the plurality of connection contexts, performing, based at least in part on the one or more additional configurations, the one or more additional measurements associated with the intent, and providing a second indication of the one or more additional measurements.

In a fourteenth aspect, alone or in combination with one or more of the first through thirteenth aspects, process 800 includes transmitting, to a network entity, signaling indicative of one or more connection contexts from the plurality of connection contexts, and receiving, from the network entity, an indication of the one connection context, wherein generating the configuration is based at least in part on receiving the indication.

In a fifteenth aspect, alone or in combination with one or more of the first through fourteenth aspects, generating the configuration comprises providing, to an AI component at the UE, the intent and the contextual information associated with the UE, and outputting, from the AI component at the UE, the configuration for the one or more measurements.

In a sixteenth aspect, alone or in combination with one or more of the first through fifteenth aspects, process 800 includes the intent corresponds to a beam management performance analysis, and the request is for information associated with the beam management performance analysis.

In a seventeenth aspect, alone or in combination with one or more of the first through sixteenth aspects, process 800 includes determining a plurality of tasks associated with the beam management performance analysis, wherein the configuration for the one or more measurements is based at least in part on the one or more measurements obtaining the information corresponding to at least one of the plurality of tasks.

In an eighteenth aspect, alone or in combination with one or more of the first through seventeenth aspects, the plurality of tasks comprise a beam coverage analysis task, a beam capacity analysis task, an AI or ML beam management performance analysis task, a beam switching performance analysis task, an AI or ML beam switching performance analysis task, a beam failure recovery performance analysis task, a beam failure cause analysis task, or a beam failure during a lower-layer triggered mobility procedure analysis task.

In a nineteenth aspect, alone or in combination with one or more of the first through eighteenth aspects, process 800 includes the configuration indicates the one or more measurements for one connection context, from a plurality of connection contexts, and the plurality of connection contexts comprise a set of frequencies, one or more cells, a TAC, a PLMN, a PN, an NPN, a time range, an operating environment of the UE, a range of speeds of the UE, a type of established connection, or a type of service.

In a twentieth aspect, alone or in combination with one or more of the first through nineteenth aspects, process 800 includes the configuration indicates one or more events associated with triggering the UE to perform the one or more measurements, and the one or more events comprise a periodic trigger, a change in the contextual information, a quality of experience at the UE that fails to satisfy a threshold, the UE detecting a coverage hole at the UE, the UE detecting a low capacity at the UE, or the UE detecting a failure event.

In a twenty-first aspect, alone or in combination with one or more of the first through twentieth aspects, the information requested by the intent comprises cell information, beam information, L1 beam measurement information, L3 beam measurement information, MAC layer information, beam failure cause information, beam failure rate information, beam switching delay information, location information associated with the UE, QoS measurement information associated with a beam, or QoS measurement information associated with beam switching.

In a twenty-second aspect, alone or in combination with one or more of the first through twenty-first aspects, process 800 includes the intent corresponds to a mobility management performance analysis, and the request is for information associated with the mobility management performance analysis.

In a twenty-third aspect, alone or in combination with one or more of the first through twenty-second aspects, process 800 includes determining a plurality of tasks associated with the mobility management performance analysis, wherein the configuration for the one or more measurements is based at least in part on the one or more measurements obtaining the information corresponding to at least one of the plurality of tasks.

In a twenty-fourth aspect, alone or in combination with one or more of the first through twenty-third aspects, the plurality of tasks comprise a coverage weakness analysis task, a capacity weakness analysis task, an AI or ML mobility management performance analysis task, a ping-pong rate analysis task, an early handover failure analysis task, a late handover failure analysis task, a wrong cell handover analysis task, an RLF cause analysis task, a suitable cell selection analysis task, a multi-connectivity performance analysis task, or a cell selection and reselection performance analysis task.

In a twenty-fifth aspect, alone or in combination with one or more of the first through twenty-fourth aspects, process 800 includes the configuration indicates the one or more measurements for one connection context, from a plurality of connection contexts, and the plurality of connection contexts comprise a set of frequencies, one or more cells, a TAC, a PLMN, a PN, an NPN, a time range, an operating environment of the UE, a range of speeds of the UE, a type of established connection, a type of service, a type of handover, a type of connectivity, or a type of connectivity state.

In a twenty-sixth aspect, alone or in combination with one or more of the first through twenty-fifth aspects, process 800 includes the configuration indicates one or more events associated with triggering the UE to perform the one or more measurements, and the one or more events comprise a periodic trigger, a change in the contextual information, a quality of experience at the UE that fails to satisfy a threshold, the UE detecting a coverage hole at the UE, the UE detecting a low capacity at the UE, the UE detecting a failure event, a switch from standalone connectivity to multi-connectivity, an addition of a secondary cell, or a cell group failure.

In a twenty-seventh aspect, alone or in combination with one or more of the first through twenty-sixth aspects, the information requested by the intent comprises cell information, beam information, L1 beam measurement information, L3 beam measurement information, radio link management information, media access control layer information, handover rate information, ping-pong rate information, trajectory information, handover failure information, RLF information, cell selection information, time information, location information, QoS measurement information associated with a beam, or QoS measurement information associated with beam switching.

In a twenty-eighth aspect, alone or in combination with one or more of the first through twenty-seventh aspects, process 800 includes the intent corresponds to an access performance analysis, and the request is for information associated with the access performance analysis.

In a twenty-ninth aspect, alone or in combination with one or more of the first through twenty-eighth aspects, process 800 includes determining a plurality of tasks associated with the access performance analysis, wherein the configuration for the one or more measurements is based at least in part on the one or more measurements obtaining the information corresponding to at least one of the plurality of tasks.

In a thirtieth aspect, alone or in combination with one or more of the first through twenty-ninth aspects, the plurality of tasks comprise a random access channel analysis task, a random access channel resource assignment analysis task, or a power ramping algorithm analysis task.

In a thirty-first aspect, alone or in combination with one or more of the first through thirtieth aspects, process 800 includes the configuration indicates the one or more measurements for one connection context, from a plurality of connection contexts, and the plurality of connection contexts comprise a set of frequencies, one or more cells, a TAC, a PLMN, a PN, an NPN, a time range, an operating environment of the UE, a range of speeds of the UE, a type of established connection, a type of service, or a type of access procedure.

In a thirty-second aspect, alone or in combination with one or more of the first through thirty-first aspects, process 800 includes the configuration indicates one or more events associated with triggering the UE to perform the one or more measurements, and the one or more events comprise a success or failure of a random access channel procedure, a feature-specific random access channel procedure being triggered, a feature associated with access procedures being initialized, or the UE switching from performing a first type of access procedure to performing a second type of access procedure.

In a thirty-third aspect, alone or in combination with one or more of the first through thirty-second aspects, the information requested by the intent comprises information associated with a purpose for the UE performing a random access channel procedure, cell information, beam information, L1 beam measurement information, L3 beam measurement information, information associated with resources for the UE performing the random access channel procedure, media access control layer information, random access channel procedure failure information, service information, time information, or location information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 2-7. Additionally, or alternatively, the apparatus 900 may be configured to perform one or more processes described herein, such as process 800 of FIG. 8. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive an intent comprising a request for information associated with communications at the UE. The communication manager 906 may generate, based at least in part on contextual information associated with the UE, a configuration for one or more measurements to obtain the information requested by the intent. The communication manager 906 may perform, based at least in part on the configuration and to obtain the information requested by the intent, the one or more measurements associated with the intent. The communication manager 906 may provide an indication of the one or more measurements.

The communication manager 906 may determine, based at least in part on the intent, a plurality of tasks associated with the intent, wherein the configuration for the one or more measurements is based at least in part on the one or more measurements obtaining the information corresponding to at least one of the plurality of tasks.

The transmission component 904 may transmit, to a network entity, signaling indicating the plurality of tasks associated with the intent.

The reception component 902 may receive, from the network entity, an indication to obtain the information corresponding to the at least one of the plurality of tasks indicated by the UE, wherein generating the configuration is based at least in part on receiving the indication.

The communication manager 906 may generate, based at least in part on the contextual information associated with the UE, one or more additional configurations for one or more additional measurements to obtain additional information for the intent, wherein the one or more additional configurations are each associated with obtaining the additional information associated with a different connection context from the plurality of connection contexts.

The communication manager 906 may perform, based at least in part on the one or more additional configurations, the one or more additional measurements associated with the intent.

The communication manager 906 may provide a second indication of the one or more additional measurements.

The transmission component 904 may transmit, to a network entity, signaling indicative of one or more connection contexts from the plurality of connection contexts.

The reception component 902 may receive, from the network entity, an indication of the one connection context, wherein generating the configuration is based at least in part on receiving the indication.

The communication manager 906 may determine a plurality of tasks associated with the beam management performance analysis, wherein the configuration for the one or more measurements is based at least in part on the one or more measurements obtaining the information corresponding to at least one of the plurality of tasks.

The communication manager 906 may determine a plurality of tasks associated with the mobility management performance analysis, wherein the configuration for the one or more measurements is based at least in part on the one or more measurements obtaining the information corresponding to at least one of the plurality of tasks.

The communication manager 906 may determine a plurality of tasks associated with the access performance analysis, wherein the configuration for the one or more measurements is based at least in part on the one or more measurements obtaining the information corresponding to at least one of the plurality of tasks.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving an intent comprising a request for information associated with communications at the UE; generating, based at least in part on contextual information associated with the UE, a configuration for one or more measurements to obtain the information requested by the intent; performing, based at least in part on the configuration and to obtain the information requested by the intent, the one or more measurements associated with the intent; and providing an indication of the one or more measurements.

Aspect 2: The method of Aspect 1, wherein the contextual information comprises a speed of the UE, a location of the UE, capability information associated with the UE, or information associated with the location of the UE.

Aspect 3: The method of any of Aspects 1-2, wherein the one or more measurements comprise one or more application layer measurements, one or more signal quality measurements, one or more performance measurements, or one or more sensor measurements.

Aspect 4: The method of any of Aspects 1-3, wherein receiving the intent comprises: receiving, by an AI component at the UE, the intent from another wireless communication device, wherein the other wireless communication device comprises a network entity, a second UE, a server associated with an application at the UE, an application server associated with a network entity, a RAN node, a network function, or a network server.

Aspect 5: The method of any of Aspects 1-4, wherein receiving the intent comprises: receiving, by a first AI component at the UE, the intent from another component of the UE, wherein the other component comprises an application at the UE, a second AI component at the UE, or a protocol layer at a modem of the UE.

Aspect 6: The method of any of Aspects 1-5, wherein the configuration indicates the one or more measurements for the UE to perform.

Aspect 7: The method of any of Aspects 1-6, wherein the configuration indicates a periodicity for performing the one or more measurements, or one or more events associated with triggering the UE to perform the one or more measurements.

Aspect 8: The method of Aspect 7, wherein the configuration indicates the one or more events associated with triggering the UE to perform the one or more measurements, the method further comprising: detecting at least one event from the one or more events associated with triggering the UE to perform the one or more measurements.

Aspect 9: The method of any of Aspects 1-8, further comprising: determining, based at least in part on the intent, a plurality of tasks associated with the intent, wherein the configuration for the one or more measurements is based at least in part on the one or more measurements obtaining the information corresponding to at least one of the plurality of tasks.

Aspect 10: The method of Aspect 9, further comprising: transmitting, to a network entity, signaling indicating the plurality of tasks associated with the intent; and receiving, from the network entity, an indication to obtain the information corresponding to the at least one of the plurality of tasks indicated by the UE, wherein generating the configuration is based at least in part on receiving the indication.

Aspect 11: The method of any of Aspects 1-10, wherein the one or more measurements obtain information associated with one connection context from a plurality of connection contexts.

Aspect 12: The method of Aspect 11, wherein the plurality of connection contexts comprise: a set of frequencies, one or more cells, a TAC, a PLMN, a PN, an NPN, a time range, an operating environment of the UE, or a range of speeds of the UE.

Aspect 13: The method of Aspect 11, wherein the intent further comprises an indication of the one connection context.

Aspect 14: The method of Aspect 11, further comprising: generating, based at least in part on the contextual information associated with the UE, one or more additional configurations for one or more additional measurements to obtain additional information for the intent, wherein the one or more additional configurations are each associated with obtaining the additional information associated with a different connection context from the plurality of connection contexts; performing, based at least in part on the one or more additional configurations, the one or more additional measurements associated with the intent; and providing a second indication of the one or more additional measurements.

Aspect 15: The method of Aspect 11, further comprising: transmitting, to a network entity, signaling indicative of one or more connection contexts from the plurality of connection contexts; and receiving, from the network entity, an indication of the one connection context, wherein generating the configuration is based at least in part on receiving the indication.

Aspect 16: The method of any of Aspects 1-15, wherein generating the configuration comprises: providing, to an AI component at the UE, the intent and the contextual information associated with the UE; and outputting, from the AI component at the UE, the configuration for the one or more measurements.

Aspect 17: The method of any of Aspects 1-16, wherein: the intent corresponds to a beam management performance analysis; and the request is for information associated with the beam management performance analysis.

Aspect 18: The method of Aspect 17, further comprising: determining a plurality of tasks associated with the beam management performance analysis, wherein the configuration for the one or more measurements is based at least in part on the one or more measurements obtaining the information corresponding to at least one of the plurality of tasks.

Aspect 19: The method of Aspect 18, wherein the plurality of tasks comprise a beam coverage analysis task, a beam capacity analysis task, an AI or ML beam management performance analysis task, a beam switching performance analysis task, an AI or ML beam switching performance analysis task, a beam failure recovery performance analysis task, a beam failure cause analysis task, or a beam failure during a lower-layer triggered mobility procedure analysis task.

Aspect 20: The method of Aspect 17, wherein: the configuration indicates the one or more measurements for one connection context, from a plurality of connection contexts; and the plurality of connection contexts comprise a set of frequencies, one or more cells, a TAC, a PLMN, a PN, an NPN, a time range, an operating environment of the UE, a range of speeds of the UE, a type of established connection, or a type of service.

Aspect 21: The method of Aspect 17, wherein: the configuration indicates one or more events associated with triggering the UE to perform the one or more measurements; and the one or more events comprise a periodic trigger, a change in the contextual information, a quality of experience at the UE that fails to satisfy a threshold, the UE detecting a coverage hole at the UE, the UE detecting a low capacity at the UE, or the UE detecting a failure event.

Aspect 22: The method of Aspect 17, wherein the information requested by the intent comprises cell information, beam information, L1 beam measurement information, L3 beam measurement information, MAC layer information, beam failure cause information, beam failure rate information, beam switching delay information, location information associated with the UE, QoS measurement information associated with a beam, or QoS measurement information associated with beam switching.

Aspect 23: The method of any of Aspects 1-22, wherein: the intent corresponds to a mobility management performance analysis; and the request is for information associated with the mobility management performance analysis.

Aspect 24: The method of Aspect 23, further comprising: determining a plurality of tasks associated with the mobility management performance analysis, wherein the configuration for the one or more measurements is based at least in part on the one or more measurements obtaining the information corresponding to at least one of the plurality of tasks.

Aspect 25: The method of Aspect 24, wherein the plurality of tasks comprise a coverage weakness analysis task, a capacity weakness analysis task, an AI or ML mobility management performance analysis task, a ping-pong rate analysis task, an early handover failure analysis task, a late handover failure analysis task, a wrong cell handover analysis task, an RLF cause analysis task, a suitable cell selection analysis task, a multi-connectivity performance analysis task, or a cell selection and reselection performance analysis task.

Aspect 26: The method of Aspect 23, wherein: the configuration indicates the one or more measurements for one connection context, from a plurality of connection contexts; and the plurality of connection contexts comprise a set of frequencies, one or more cells, a TAC, a PLMN, a PN, an NPN, a time range, an operating environment of the UE, a range of speeds of the UE, a type of established connection, a type of service, a type of handover, a type of connectivity, or a type of connectivity state.

Aspect 27: The method of Aspect 23, wherein: the configuration indicates one or more events associated with triggering the UE to perform the one or more measurements; and the one or more events comprise a periodic trigger, a change in the contextual information, a quality of experience at the UE that fails to satisfy a threshold, the UE detecting a coverage hole at the UE, the UE detecting a low capacity at the UE, the UE detecting a failure event, a switch from standalone connectivity to multi-connectivity, an addition of a secondary cell, or a cell group failure.

Aspect 28: The method of Aspect 23, wherein the information requested by the intent comprises cell information, beam information, L1 beam measurement information, L3 beam measurement information, radio link management information, media access control layer information, handover rate information, ping-pong rate information, trajectory information, handover failure information, RLF information, cell selection information, time information, location information, QoS measurement information associated with a beam, or QoS measurement information associated with beam switching.

Aspect 29: The method of any of Aspects 1-28, wherein: the intent corresponds to an access performance analysis; and the request is for information associated with the access performance analysis.

Aspect 30: The method of Aspect 29, further comprising: determining a plurality of tasks associated with the access performance analysis, wherein the configuration for the one or more measurements is based at least in part on the one or more measurements obtaining the information corresponding to at least one of the plurality of tasks.

Aspect 31: The method of Aspect 30, wherein the plurality of tasks comprise a random access channel analysis task, a random access channel resource assignment analysis task, or a power ramping algorithm analysis task.

Aspect 32: The method of Aspect 29, wherein: the configuration indicates the one or more measurements for one connection context, from a plurality of connection contexts; and the plurality of connection contexts comprise a set of frequencies, one or more cells, a TAC, a PLMN, a PN, an NPN, a time range, an operating environment of the UE, a range of speeds of the UE, a type of established connection, a type of service, or a type of access procedure.

Aspect 33: The method of Aspect 29, wherein: the configuration indicates one or more events associated with triggering the UE to perform the one or more measurements; and the one or more events comprise a success or failure of a random access channel procedure, a feature-specific random access channel procedure being triggered, a feature associated with access procedures being initialized, or the UE switching from performing a first type of access procedure to performing a second type of access procedure.

Aspect 34: The method of Aspect 23, wherein the information requested by the intent comprises information associated with a purpose for the UE performing a random access channel procedure, cell information, beam information, L1 beam measurement information, L3 beam measurement information, information associated with resources for the UE performing the random access channel procedure, media access control layer information, random access channel procedure failure information, service information, time information, or location information.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

Aspect 42: A device comprising a processing system that includes one or more processors and one or more code-storing memories coupled with the one or more processors, the processing system configured to cause the device to perform the method of one or more of Aspects 1-34.

Aspect 43: A device comprising a processing system that includes processor circuitry and code-storing memory circuitry, the processing system configured to cause the device to perform the method of one or more of Aspects 1-34.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive an intent comprising a request for information associated with communications at the UE;
generate, based at least in part on contextual information associated with the UE, a configuration for one or more measurements to obtain the information requested by the intent;
perform, based at least in part on the configuration and to obtain the information requested by the intent, the one or more measurements associated with the intent; and
provide an indication of the one or more measurements.

2. The UE of claim 1, wherein the contextual information comprises a speed of the UE, a location of the UE, capability information associated with the UE, or information associated with the location of the UE.

3. The UE of claim 1, wherein the one or more measurements comprise one or more application layer measurements, one or more signal quality measurements, one or more performance measurements, or one or more sensor measurements.

4. The UE of claim 1, wherein, to receive the intent, the one or more processors individually or collectively are configured to:
receive, by an artificial intelligence component at the UE, the intent from another wireless communication device, wherein the other wireless communication device comprises a network entity, a UE, a server associated with an application at the UE, an application server associated with a network entity, a radio access network node, a network function, or a network server.

5. The UE of claim 1, wherein, to receive the intent comprises, the one or more processors individually or collectively are configured to:
receive, by a first artificial intelligence component at the UE, the intent from another component of the UE, wherein the other component comprises an application at the UE, a second artificial intelligence component at the UE, or a protocol layer at a modem of the UE.

6. The UE of claim 1, wherein the configuration indicates the one or more measurements for the UE to perform.

7. The UE of claim 1, wherein the configuration indicates a periodicity for performing the one or more measurements, or one or more events associated with triggering the UE to perform the one or more measurements.

8. The UE of claim 7, wherein the configuration indicates the one or more events associated with triggering the UE to perform the one or more measurements, and wherein the one or more processors individually or collectively are configured to:
detect at least one event from the one or more events associated with triggering the UE to perform the one or more measurements.

9. The UE of claim 1, wherein the one or more processors individually or collectively are configured to:
determine, based at least in part on the intent, a plurality of tasks associated with the intent, wherein the configuration for the one or more measurements is based at least in part on the one or more measurements obtaining the information corresponding to at least one of the plurality of tasks.

10. The UE of claim 9, wherein the one or more processors individually or collectively are configured to:
transmit, to a network entity, signaling indicating the plurality of tasks associated with the intent; and
receive, from the network entity, an indication to obtain the information corresponding to the at least one of the plurality of tasks indicated by the UE, wherein generating the configuration is based at least in part on receiving the indication.

11. The UE of claim 1, wherein the one or more measurements obtain information associated with one connection context from a plurality of connection contexts.

12. The UE of claim 11, wherein the plurality of connection contexts comprise:
a set of frequencies, one or more cells, a tracking area code (TAC), a public land mobile network (PLMN), a private network (PN), a non-public network (NPN), a time range, an operating environment of the UE, or a range of speeds of the UE.

13. The UE of claim 11, wherein the intent further comprises an indication of the one connection context.

14. The UE of claim 11, wherein the one or more processors individually or collectively are configured to:
generate, based at least in part on the contextual information associated with the UE, one or more additional configurations for one or more additional measurements to obtain additional information for the intent, wherein the one or more additional configurations are each associated with obtaining the additional information associated with a different connection context from the plurality of connection contexts;
perform, based at least in part on the one or more additional configurations, the one or more additional measurements associated with the intent; and
provide a second indication of the one or more additional measurements.

15. The UE of claim 11, wherein the one or more processors individually or collectively are configured to:
transmit, to a network entity, signaling indicative of one or more connection contexts from the plurality of connection contexts; and
receive, from the network entity, an indication of the one connection context, wherein generating the configuration is based at least in part on receiving the indication.

16. The UE of claim 1, wherein, to generate the configuration, the one or more processors individually or collectively are configured to:
provide, to an artificial intelligence component at the UE, the intent and the contextual information associated with the UE; and
output, from the artificial intelligence component at the UE, the configuration for the one or more measurements.

17. The UE of claim 1, wherein:
the intent corresponds to a beam management performance analysis; and
the request is for information associated with the beam management performance analysis.

18. The UE of claim 17, wherein the one or more processors individually or collectively are configured to:
determine a plurality of tasks associated with the beam management performance analysis, wherein the configuration for the one or more measurements is based at least in part on the one or more measurements obtaining the information corresponding to at least one of the plurality of tasks.

19. The UE of claim 17, wherein:
the configuration indicates the one or more measurements for one connection context, from a plurality of connection contexts; and
the plurality of connection contexts comprise a set of frequencies, one or more cells, a tracking area code (TAC), a public land mobile network (PLMN), a private network (PN), a non-public network (NPN), a time range, an operating environment of the UE, a range of speeds of the UE, a type of established connection, or a type of service.

20. The UE of claim 17, wherein:
the configuration indicates one or more events associated with triggering the UE to perform the one or more measurements; and
the one or more events comprise a periodic trigger, a change in the contextual information, a quality of experience at the UE that fails to satisfy a threshold, the UE detecting a coverage hole at the UE, the UE detecting a low capacity at the UE, or the UE detecting a failure event.

21. The UE of claim 1, wherein:
the intent corresponds to a mobility management performance analysis; and
the request is for information associated with the mobility management performance analysis.

22. The UE of claim 21, wherein the one or more processors individually or collectively are configured to:
determine a plurality of tasks associated with the mobility management performance analysis, wherein the configuration for the one or more measurements is based at least in part on the one or more measurements obtaining the information corresponding to at least one of the plurality of tasks.

23. The UE of claim 21, wherein:
the configuration indicates the one or more measurements for one connection context, from a plurality of connection contexts; and
the plurality of connection contexts comprise a set of frequencies, one or more cells, a tracking area code (TAC), a public land mobile network (PLMN), a private network (PN), a non-public network (NPN), a time range, an operating environment of the UE, a range of speeds of the UE, a type of established connection, a type of service, a type of handover, a type of connectivity, or a type of connectivity state.

24. The UE of claim 21, wherein:
the configuration indicates one or more events associated with triggering the UE to perform the one or more measurements; and
the one or more events comprise a periodic trigger, a change in the contextual information, a quality of experience at the UE that fails to satisfy a threshold, the UE detecting a coverage hole at the UE, the UE detecting a low capacity at the UE, the UE detecting a failure event, a switch from standalone connectivity to multi-connectivity, an addition of a secondary cell, or a cell group failure.

25. The UE of claim 1, wherein:
the intent corresponds to an access performance analysis; and
the request is for information associated with the access performance analysis.

26. The UE of claim 25, wherein the one or more processors individually or collectively are configured to:
determine a plurality of tasks associated with the access performance analysis, wherein the configuration for the one or more measurements is based at least in part on the one or more measurements obtaining the information corresponding to at least one of the plurality of tasks.

27. The UE of claim 25, wherein:
the configuration indicates the one or more measurements for one connection context, from a plurality of connection contexts; and
the plurality of connection contexts comprise a set of frequencies, one or more cells, a tracking area code (TAC), a public land mobile network (PLMN), a private network (PN), a non-public network (NPN), a time range, an operating environment of the UE, a range of speeds of the UE, a type of established connection, a type of service, or a type of access procedure.

28. A method of wireless communication performed by a user equipment (UE), comprising:
receiving an intent comprising a request for information associated with communications at the UE;
generating, based at least in part on contextual information associated with the UE, a configuration for one or more measurements to obtain the information requested by the intent;
performing, based at least in part on the configuration and to obtain the information requested by the intent, the one or more measurements associated with the intent; and
providing an indication of the one or more measurements.

29. A non-transitory computer-readable medium storing a set of instructions for wireless communication, the set of instructions comprising:
one or more instructions that, when executed by one or more processors of a user equipment (UE), cause the UE to:
receive an intent comprising a request for information associated with communications at the UE;
generate, based at least in part on contextual information associated with the UE, a configuration for one or more measurements to obtain the information requested by the intent;
perform, based at least in part on the configuration and to obtain the information requested by the intent, the one or more measurements associated with the intent; and
provide an indication of the one or more measurements.

30. An apparatus for wireless communication, comprising:
means for receiving an intent comprising a request for information associated with communications at the apparatus;
means for generating, based at least in part on contextual information associated with the apparatus, a configuration for one or more measurements to obtain the information requested by the intent;
means for performing, based at least in part on the configuration and to obtain the information requested by the intent, the one or more measurements associated with the intent; and
means for providing an indication of the one or more measurements.
